(19) United States
(12) Patent Application Publication
(10) Pub. No.: US 2015/0304909 A1
(43) Pub. Date: Oct. 22, 2015

(54) BASE STATION DEVICE, TERMINAL DEVICE, COMMUNICATION SYSTEM, TRANSMISSION METHOD, RECEPTION METHOD, COMMUNICATION METHOD, AND INTEGRATED CIRCUIT

(71) Applicant: SHARP KABUSHIKI KAISHA, Osaka-shi, Osaka (JP)

(72) Inventors: Takashi YOSHIMOTO, Osaka-shi (JP); Kozue YOKOMAKURA, Osaka-shi (JP); Ryota YAMADA, Osaka-shi (JP); Katsuya KATO, Osaka-shi (JP)

(73) Assignee: Sharp Kabushiki Kaisha, Osaka-shi, Osaka (JP)

(21) Appl. No.: 14/439,733

(22) PCT Filed: Oct. 31, 2013
(86) PCT No.: PCT/JP2013/079597

§ 371 Date: Apr. 30, 2015

(30) Foreign Application Priority Data
Nov. 2, 2012 (JP) 2012-242336

(51) Int. Cl. H04W 36/00; H04W 52/34; H04W 72/04

(52) U.S. Cl. CPC H04W 36/0083; H04W 72/042; H04W 52/34

(57) ABSTRACT

Provided are a communication system and a communication method which efficiently control connecting and switching over for a second base station device and a terminal device and which enable traffic distribution in a communication system including a first base station device, at least one second base station device, and the terminal device which is connected to the first base station device or the second base station device. In the communication system which includes the first base station device, at least one second base station device, and the terminal device connected to the first base station device or the second base station device, a transmission unit of the first base station device transmits channels in the downlink including target base station recognition information and channels in the downlink including system information of the second base station device in order to notify whether or not a subsequent connection destination is the second base station device to the terminal device.

### TECHNICAL FIELD

The present invention relates to a base station device, a terminal device, a communication system, a transmission method, a reception method, a communication method, and an integrated circuit.

This application claims priority of Japanese Patent Application No. 2012-242336 filed on Nov. 2, 2012, the contents of which are incorporated herein by reference.

### BACKGROUND ART

In a radio communication system, such as Wideband Code Division Multiple Access (WCDMA), Long Term Evolution (LTE), and LTE-Advanced (LTE-A) based on 3rd Generation Partnership Project (3GPP) or Worldwide Interoperability for Microwave Access (WiMAX) based on the Institute of Electrical and Electronics Engineers (IEEE), a communication service area is formed through cell configuration in which a plurality of base station devices are arranged. The cells are ranges in which the base station devices can be connected to a terminal device (mobile station device or User Equipment (UE)).

In a system (hereinafter, cellular system) which is formed through the cell configuration, the distribution of traffic is requested in accordance with increase in traffic due to increase in large-capacity service. In order to satisfy the request, a technology of arranging a plurality of base station devices such that some or the entirety of the range of a cell (macro cell) which is formed by a main base station device (macro base station) overlaps with the ranges of cells (pico-cells, femto-cells, small cells, or the like) which are formed by low-power base station devices (pico-cell base stations, femto-cell base stations, small cell base stations, or the like) has been proposed (called Heterogeneous Network (HetNet) deployment (NPL 1)). Here, the low-power base station devices indicate base station devices which have lower maximum transmission power than the maximum transmission power of the macro base station.

FIG. 15 is a schematic diagram illustrating a cellular system in the downlink in which a plurality of base station devices having different cell radii are arranged according to the related art. The respective base station devices are arranged such that the cell 1000-1a (macro cell) of a macro base station 1000-1 overlaps with the cell 1000-2a (small cell) of a base station device 1000-2 and the cell 1000-3a (small cell) of a base station device 1000-3, which are low-power base stations having lower maximum transmission power than the macro base station device. The base station devices 1000-1, 1000-2, and 1000-3 are connected through an optical fiber, an X2 interface, or another wired line or radio line. Pieces of control information, which are necessary between the base station devices, are exchanged through the line.

A plurality of terminal devices exist within the cells. In FIG. 15, a terminal device 2000-1 is radio-connected (r11) to the base station device 1000-1, a terminal device 2000-2 is radio-connected (r22) to the base station device 1000-2, and a terminal device 2000-3 is radio-connected (r33) to the base station device 1000-3. Control is performed such that the respective terminal devices are radio-connected to the base station devices which can receive signals at, for example, the maximum reception field intensity. When the control is performed, for example, bias is added to the reception field intensity (NPL 2). Therefore, the distribution of traffic is realized.

In the cellular system, various pieces of control information (control channels and control signals) are transmitted and received between the base station devices or between the base station device and the terminal device. FIG. 16 illustrates an example of the transmission frame format of the cellular system in the downlink according to the related art. In FIG. 16, a single transmission frame includes 10 sub-frames (sub-frame indexes #0 to #9).

In the frame format of FIG. 16, as a physical signal or a physical channel in the downlink, a Cell-specific Reference Signal ((CRS), a black section in the drawing), a Physical Downlink Shared CHannel ((PDSCH), a channel which mainly transmit information data, a white blank section in the drawing), a Physical Downlink Control CHannel ((PDCCH), a hatched section in the drawing), a Primary Synchronization Signal ((PSS), an upper right shaded section in the drawing), a Secondary Synchronization Signal ((SSS), an upper left shaded section in the drawing), and a Physical Broadcast Channel ((PBCH), a lattice section in the drawing) are mapped.

The CRS is a signal which is used for channel estimation. The PDSCH is a channel which is mainly used to transmit information data. The PDCCH is a channel which is used to notify radio resource allocation information of the terminal device. The PSS is a signal which is mainly used for symbol timing synchronization. The SSS is a signal which is used for frame synchronization. The PBCH is a channel which transmits control information (for example, Master Information Block (MIB) in LTE) that is necessary for the terminal device to receive the PDSCH.

The respective base station devices 1000-1, 1000-2, and 1000-3 in FIG. 15 transmit respective pieces of control information to the terminal devices 2000-1, 2000-2, and 2000-3 based on the transmission frame format.

### CITATION LIST

### Non Patent Literature

NPL 1: 3rd Generation Partnership Project; Technical Specification Group Radio Access Network; Further Advancements for E-UTRA Physical Layer Aspects (Release 9), 3GPP TR36.814 v9.0.0(2010-03) URL: http://www.3gpp.org/ftp/Specs/html-info/36814.htm
NPL 2: R1-100607, 3GPP TSG-RAN WG1 meeting #59bis Valencia, Spain, 18-22 Jan. 2010

### SUMMARY OF INVENTION

### Technical Problem

However, in the cellular system in which the plurality of base station devices having different cell radii are arranged, it is considered that the number of low-power base station devices which are arranged in the range of the macro cell increases in order to distribute loads for increase in added traffics. In such an environment, if the entire low-power base station devices include the same control functions as the main base station device, there is a problem in that connecting and switching over for the base station devices (the main base station device and the low-power base station device) and the terminal device are ineffectively controlled.

The present invention is made in consideration of the above problem, and an object of the present invention is to provide a base station device, a terminal device, a communication system, a transmission method, a reception method, a communication method and an integrated circuit which, in a communication system including a plurality of base station devices arranged such that the entirety or some of the connectable ranges of the respective base station device are overlapped with each other, efficiently control connecting and switching over for the base station devices and the terminal device and which enable traffic distribution.

### Solution to Problem

In order to solve the above problem, the respective configurations of a base station device, a terminal device, a communication system, a transmission method, a reception method, a communication method, and an integrated circuit according to the present invention are as provided below.

(1) According to an aspect of the present invention, there is provided a base station device, which is a first base station device of a communication system that includes the first base station device, at least one second base station device, and a terminal device which is connected to the first base station device or the second base station device, the base station device including: a transmission unit that transmits channels in the downlink including target base station recognition information and channels in the downlink including system information of the second base station device in order to provide a notification of whether or not a subsequent connection destination is the second base station device to the terminal device.

(2) In the base station device which is the above-described first base station device according to the aspect of the present invention, the target base station recognition information may be information relevant to transmission power of the base station device.

(3) In the base station device which is the above-described first base station device according to the aspect of the present invention, the target base station recognition information may be information relevant to a length of a guard interval of the base station device.

(4) In the base station device which is the above-described first base station device according to the aspect of the present invention, the target base station recognition information may be information relevant to a usable frequency band of the base station device.

(5) In the base station device which is the above-described first base station device according to the aspect of the present invention, the target base station recognition information may be positional information of the base station device.

(6) In the base station device which is the above-described first base station device according to the aspect of the present invention, the transmission unit may transmit the target base station recognition information in a case in which the subsequent connection destination is the second base station device.

(7) In the base station device which is the above-described first base station device according to the aspect of the present invention, the base station device may further include a data channel generation unit that generates data channels in the downlink including the target base station recognition information.

(8) According to another aspect of the present invention, there is provided a terminal device of a communication system that includes a first base station device, at least one second base station device, and the terminal device which is connected to the first base station device or the second base station device, the terminal device including: a reception unit that receives channels in the downlink including target base station recognition information and channels in the downlink including system information of the second base station device from the first base station device in order to provide a notification of whether or not a subsequent connection destination is the second base station device to the terminal device; and a transmission unit that transmits signals based on a transmission frame format of the second base station device in a case in which the subsequent connection destination is the second base station device.

(9) In the terminal device which is the above-described terminal device according to the aspect of the present invention, the transmission unit may transmit signals based on the transmission frame format of the second base station device in a case in which the channels in the downlink including the target base station recognition information are received.

(10) In the terminal device which is the above-described terminal device according to the aspect of the present invention, the transmission unit may add a guard interval having a length based on the transmission symbol format of the second base station device in a case in which the subsequent connection destination is the second base station device.

(11) In the terminal device which is the above-described terminal device according to the aspect of the present invention, the reception unit may acquire the system information of the second base station device from the channels in the downlink which are received from the first base station device in a case in which a higher layer recognizes that the subsequent connection destination is the second base station device.

(12) In the terminal device which is the above-described terminal device according to the aspect of the present invention, the target base station recognition information may be information relevant to transmission power of the base station device.

(13) In the terminal device which is the above-described terminal device according to the aspect of the present invention, the target base station recognition information may be information relevant to the length of the guard interval of the base station device.

(14) In the terminal device which is the above-described terminal device according to the aspect of the present invention, the target base station recognition information may be the information relevant to a usable frequency band of the base station device.

(15) In the terminal device which is the above-described terminal device according to the aspect of the present invention, the target base station recognition information may be positional information of the base station device.

(16) According to still another aspect of the present invention, there is provided a communication system including: a first base station device; at least one second base station device that has lower transmission power than the first base station device; and a terminal device that is connected to the first base station device or the second base station device. The first base station device includes a transmission unit that transmits channels in the downlink including target base station recognition information and channels in the downlink including system information of the second base station device in order to provide a notification of whether or not a subsequent connection destination is the second base station device to the terminal device. The terminal device includes a reception unit that receives the channels in the downlink including the target base station recognition information and the channels in the downlink including the system information of the second base station device, and a higher layer that recognizes whether or not the subsequent connection destination is the second base station device from the target base station recognition information.

(17) According to still another aspect of the present invention, there is provided a transmission method of a first base station device of a communication system which includes the first base station device, at least one second base station device that has lower transmission power than the first base station device, and a terminal device that is connected to the first base station device or the second base station device, the transmission method including: transmitting channels in the downlink including target base station recognition information and channels in the downlink including system information of the second base station device in order to provide a notification of whether or not a subsequent connection destination is the second base station device to the terminal device.

(18) According to still another aspect of the present invention, there is provided a reception method of a terminal device of a communication system which includes a first base station device, at least one second base station device that has lower transmission power than the first base station device, and the terminal device that is connected to the first base station device or the second base station device, the reception method including: receiving channels in the downlink including target base station recognition information and channels in the downlink including system information of the second base station device from the first base station device in order to provide a notification of whether or not a subsequent connection destination is the second base station device to the terminal device; and transmitting signals based on a transmission frame format of the second base station device in a case in which the subsequent connection destination is the second base station device.

(19) According to still another aspect of the present invention, there is provided a communication method of a communication system which includes a first base station device, at least one second base station device that has lower transmission power than the first base station device, and a terminal device that is connected to the first base station device or the second base station device, the communication method including: transmitting channels in the downlink including target base station recognition information and channels in the downlink including system information of the second base station device in order to provide a notification of whether or not a subsequent connection destination is the second base station device to the terminal device in the first base station device; receiving the channels in the downlink including the target base station recognition information and the channels in the downlink including the system information of the second base station device in the terminal device; and transmitting signals based on the transmission frame format of the second base station device in a case in which the subsequent connection destination is the second base station device.

(20) According to still another aspect of the present invention, there is provided an integrated circuit of a first base station device of a communication system which includes the first base station device, at least one second base station device that has lower transmission power than the first base station device, and a terminal device that is connected to the first base station device or the second base station device, the integrated circuit including a function of: transmitting channels in the downlink including target base station recognition information and channels in the downlink including system information of the second base station device in order to provide a notification of whether or not a subsequent connection destination is the second base station device to the terminal device.

(21) According to still another aspect of the present invention, there is provided an integrated circuit of a terminal device of a communication system which includes a first base station device, at least one second base station device that has lower transmission power than the first base station device, and the terminal device that is connected to the first base station device or the second base station device, the integrated circuit including functions of: receiving channels in the downlink including target base station recognition information and channels in the downlink including system information of the second base station device from the first base station device in order to provide a notification of whether or not a subsequent connection destination is the second base station device to the terminal device; and transmitting signals based on a transmission frame format of the second base station device in a case in which the subsequent connection destination is the second base station device.

(22) According to still another aspect of the present invention, there is provided an integrated circuit of a communication system which includes a first base station device, at least one second base station device that has lower transmission power than the first base station device, and a terminal device that is connected to the first base station device or the second base station device, the integrated circuit including functions of: transmitting channels in the downlink including target base station recognition information and channels in the downlink including system information of the second base station device in order to provide a notification of whether or not a subsequent connection destination is the second base station device to the terminal device in the first base station device; receiving the channels in the downlink including the target base station recognition information and the channels in the downlink including the system information of the second base station device in the terminal device; and transmitting signals based on the transmission frame format of the second base station device in a case in which the subsequent connection destination is the second base station device.

### Advantageous Effects of Invention

According to the aspects of the present invention, in the communication system in which the plurality of base station devices are arranged such that the entire or some of the connectable ranges of the respective base station devices overlap with each other, it is possible to reduce the control information of the low-power base station device, and thus it is possible to efficiently control connecting and switching over for the base station device and the terminal device.

### BRIEF DESCRIPTION OF DRAWINGS

FIG. 1 is a schematic diagram illustrating an example a communication system in which a plurality of base station devices having different cell radii are arranged in the downlink according to an embodiment of the present invention.

FIG. 2 is a diagram illustrating an aspect of a downlink transmission frame format in the communication system according to a first embodiment.

FIG. 3 is a diagram illustrating an aspect of an uplink transmission frame format in the communication system according to the first embodiment.

FIG. 4 is a diagram illustrating another aspect of a transmission frame format of the communication system according to the first embodiment.

FIG. 5 is a block diagram illustrating a first base station device according to the first embodiment.

FIG. 6 is a block diagram illustrating a second base station device according to the first embodiment.

FIG. 7 is a schematic diagram illustrating a transmission symbol format according to the first embodiment.

FIG. 8 is a block diagram illustrating a terminal device according to the first embodiment.

FIG. 9 is a sequence diagram in which the terminal device in the communication system according to the first embodiment is connected to the second base station device.

FIG. 10 is a diagram illustrating another aspect of the transmission frame format of the communication system according to the first embodiment.

FIG. 11 is a diagram illustrating another aspect of the transmission frame format of the communication system according to the first embodiment.

FIG. 12 is a diagram illustrating another aspect of the transmission frame format of the communication system according to the first embodiment.

FIG. 13 is a sequence diagram in which a terminal device in a communication system according to a second embodiment is connected to the second base station device.

FIG. 14 is a sequence diagram in which a terminal device in a communication system according to a fifth embodiment is connected to the second base station device.

FIG. 15 is a schematic diagram illustrating a cellular system in which a plurality of base station devices having different cell radii are arranged in the downlink according to the related art.

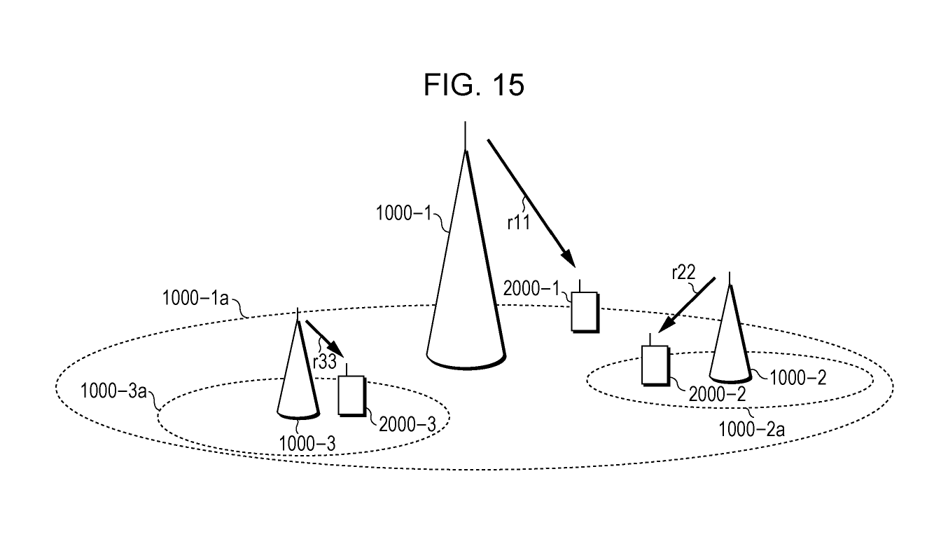

FIG. 16 is a diagram illustrating an example of the transmission frame format of the cellular system in the downlink according to the related art.

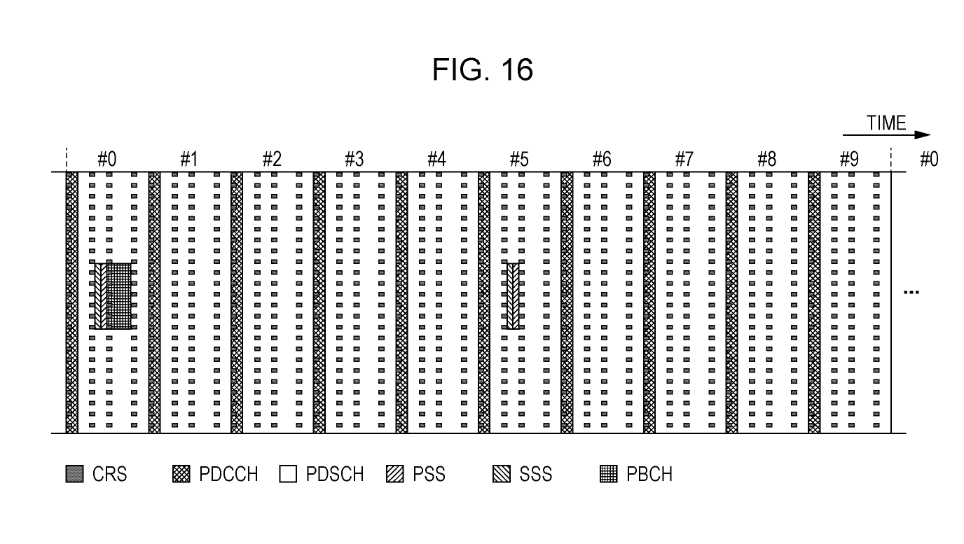

### DESCRIPTION OF EMBODIMENTS

Hereinafter, embodiments of the present invention will be described with reference to the accompanying drawings.

In embodiments below, an example will be described in which a base station device (eNodeB, a transmission station, a transmission device, a transmission point, or an Access Point (AP)) and a terminal device (a terminal, a mobile station device, a mobile terminal, a reception point, a reception terminal, a reception device, or User Equipment (UE)), which are included in a communication system, perform data transmission using an Orthogonal Frequency Division Multiplexing (OFDM) method. Meanwhile, the embodiment is not limited thereto, and other transmission schemes, for example, a single carrier transmission schemes, such as narrow band single carrier transmission, Single Carrier-Frequency Division Multiple Access (SC-FDMA) and Discrete Fourier Transform-spread-OFDM (DFT-s-OFDM), and a multi-carrier transmission schemes, such as Multiple Carrier-Code Division Multiple Access (MC-CDMA), may be used. In addition, an example of the communication system according to the embodiment of the present invention includes a radio communication system, such as Wideband Code Division Multiple Access (W-CDMA), Long Term Evolution (LTE) and LTE-Advanced (LTE-A) based on the 3rd Generation Partnership Project (3GPP), or Worldwide Interoperability for Microwave Access (WiMAX) based on the Institute of Electrical and Electronics Engineers (IEEE), but the example of the communication system is not limited thereto.

### First Embodiment

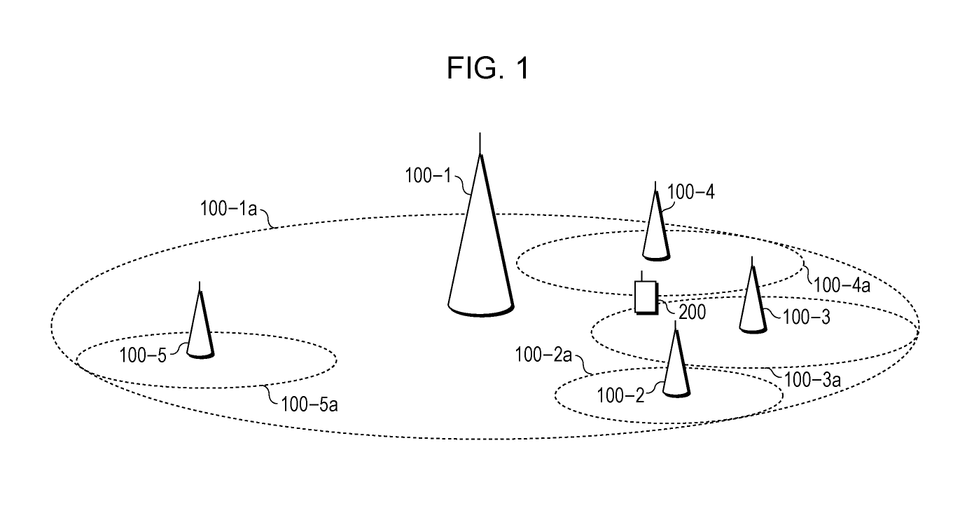

The communication system according to the embodiment of the present invention includes a plurality of base station devices and a plurality of terminal devices. FIG. 1 is a schematic diagram illustrating an example of the communication system according to the embodiment of the present invention in the downlink in which the plurality of base station devices having different cell radii are arranged.

In FIG. 1, base station devices 100-2 to 100-5 (second base station devices, small cell base station devices, or low-power base station devices) are arranged such that the cells 100-2a to 100-5a (for example, pico-cells, femto-cells, or small cells) thereof overlap with the cell 100-la (for example, a macro cell) of a base station device 100-1 (a first base station device or a macro cell base station device). The system frequencies of the first base station device and the second base station devices may be different. The transmission power of the first base station device and the second base station devices may be different. It is possible to arrange the second base station devices indoors. It is possible to densely arrange the second base station devices within the cell of the first base station device.

It is possible to use base station devices, which have lower transmission power than the first base station device, as the second base station devices. The first base station device and the second base station devices may be classified as a cell which supports an already serviced method and which is backward compatible and cells which are newly defined and are not backward compatible.

The base station devices are connected to each other through a backhaul line using a wired line or a wireless line such as an optical fiber, an Internet line, or an X2 interface. A terminal device 200 is a terminal device which exists within the cell 100-la of the base station device 100-1.

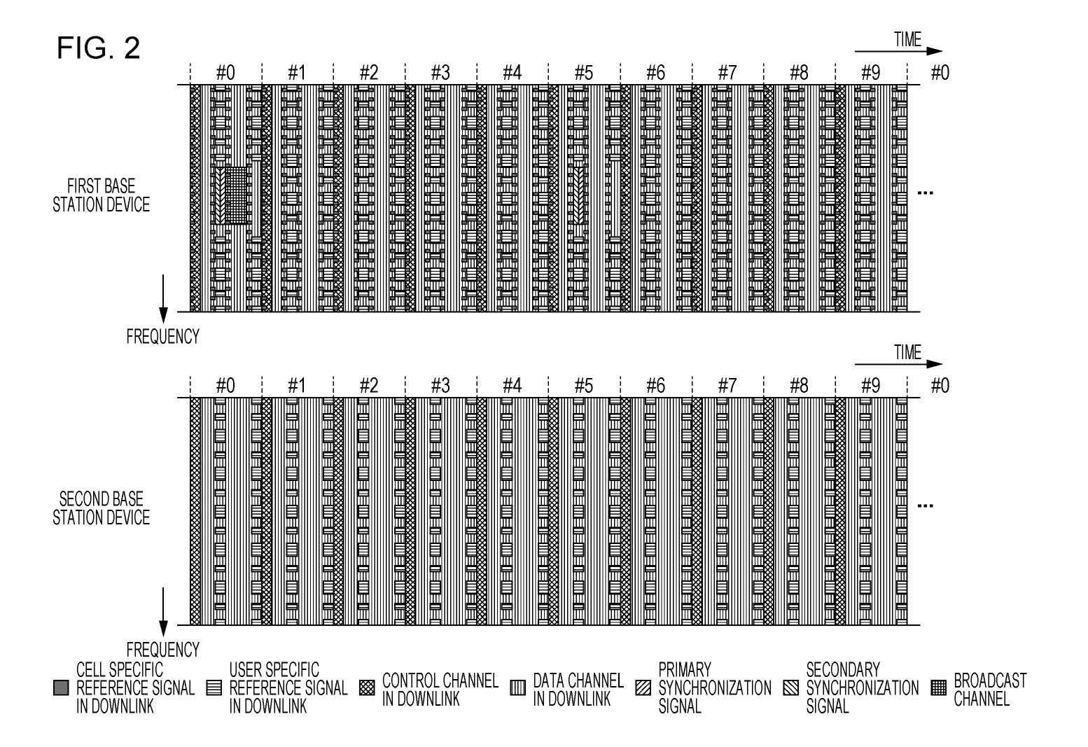

FIG. 2 illustrates an aspect of a downlink transmission frame format of the communication system according to the first embodiment. FIG. 2 illustrates the downlink transmission frame format in Frequency Division Duplex (FDD). FIG. 2 illustrates a case in which a single transmission frame format includes 10 sub-frames (#0 to #9). In addition, a sub-frame includes a plurality of OFDM symbols. For example, in LTE-A, a sub-frame includes 14 OFDM symbols.

An upper stage of FIG. 2 illustrates the downlink transmission frame format of the first base station device. In the transmission frame format of the upper stage in FIG. 2, data channels in the downlink, control channels in the downlink, cell specific reference signals in the downlink, user specific reference signals in the downlink, primary synchronization signals, secondary synchronization signals, and broadcast channels are arranged. The first base station device allocates (performs resource mapping) the various channels and signals to resource elements based on the transmission frame format. The resource element refers to the smallest unit for arranging a signal. In OFDM transmission, the resource element is a unit for arrange a signal which includes a single sub-carrier and a single OFDM symbol.

A lower stage of FIG. 2 illustrates the downlink transmission frame format of the second base station device. In the transmission frame format of the lower stage in FIG. 2, the data channels in the downlink, the control channels in the downlink, and the user specific reference signals in the downlink are arranged. The second base station device maps the various channels and the signals onto the resource elements based on the transmission frame format.

For example, in LTE-A, it is possible to use a Physical Downlink Shared CHannel (PDSCH) as the data channel in the downlink. It is possible to use a Physical Downlink Control CHannel (PDCCH) as the control channel in the downlink. It is possible to use a Cell-specific Reference Signal (CRS) as the cell specific reference signal in the downlink. It is possible to use a Channel State Information (CSI)-RS or DeModulation (DM)-RS as the user specific reference signal in the downlink. It is possible to use a Primary Synchronization Signal (PSS) as the primary synchronization signal and it is possible to use a Secondary Synchronization Signal (SSS) as the secondary synchronization signal. It is possible to use a Physical Broadcast CHannel (PBCH) as the broadcast channel.

It is possible to use the data channels in the downlink in order to transmit the user data (information data) of the terminal device, which is connected to the base station device, in the downlink. It is possible to use the data channels in the downlink in order to notify (to provide a connection destination instruction) the terminal device of a base station device (target base station device) which is a subsequent connection destination (handover destination). It is possible to use the data channels in the downlink in order to notify the terminal device of target base station recognition information. The target base station recognition information is information for recognizing whether the base station device, which is instructed as the connection destination, is the first base station device or the second base station device. It is possible to use the control channels in the downlink of the first base station device in order to notify the terminal of system information for the second base station device.

For example, it is possible to use Radio Resource Control (RRC) signaling in order to instruct the connection destination, to notify the target base station recognition information, and to notify the system information. The RRC signaling corresponds to control signals included in the PBCH and the PDSCH, and corresponds to quasi-static (semi-static) signaling in which the amount of transmittable information is large and which has a low update (transmission) frequency, compared to the PDCCH.

It is possible to use the control channels in the downlink in order to notify the terminal device (user), which is connected to the base station device, of radio resource allocation information. It is possible to use the control channels in the downlink in order to instruct the connection destination, to notify the target base station recognition information, and to notify the system information.

The cell specific reference signals in the downlink are already-known signals which are uniquely allocated for the respective cells, and the user specific reference signals in the downlink are already-known signals which are uniquely allocated for the respective users. The reference signals are signals which are used such that respective terminal devices estimate the communication qualities between the respective terminal devices and base station devices which transmit the reference signals. The communication qualities include channels (a frequency response and an impulse response), reception power, interference power, a reception Signal to Noise power Ratio (SNR), a reception Signal to Interference and Noise power Ratio (SINR), and the like.

The synchronization signals are already-known signals which are used for frame synchronization, symbol synchronization, and cell searching. In the upper stage of FIG. 2, the primary synchronization signals, which are used for the symbol synchronization, and the secondary synchronization signals, which are used for the frame synchronization, are allocated. In addition, it is possible for the terminal device to perform the cell searching using the primary synchronization signals and the secondary synchronization signals. It is possible to use the broadcast channels in order to transmit control information (for example, Master Information Block (MIB) in LTE) which is necessary for the terminal device to receive the data channels in the downlink.

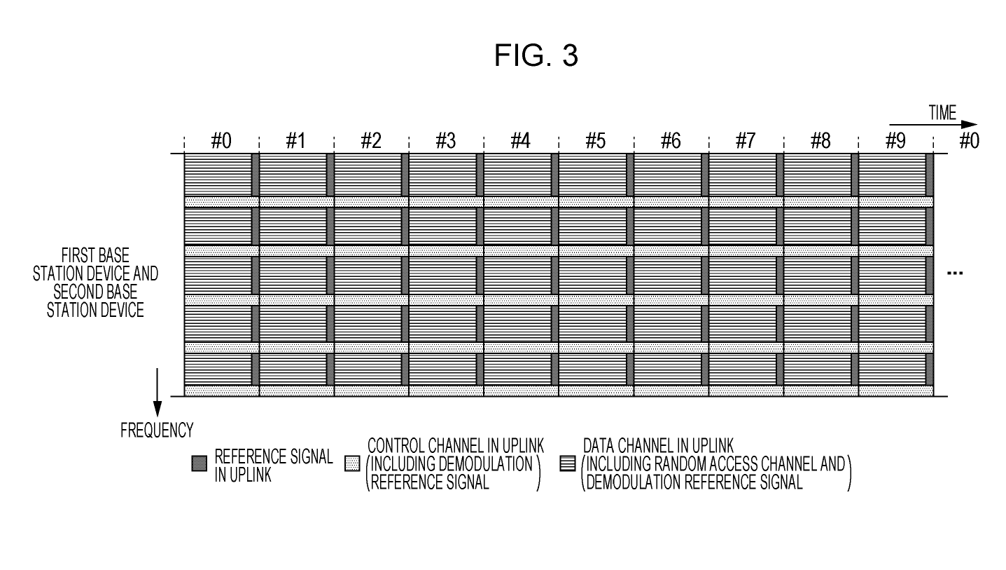

FIG. 3 illustrates an aspect of the uplink transmission frame format of the communication system according to the first embodiment. FIG. 3 illustrates a downlink transmission frame format in Frequency Division Duplex (FDD). FIG. 2 shows a case in which a single transmission frame format includes 10 sub-frames (#0 to #9).

In the transmission frame format of FIG. 3, data channels in the uplink, control channels in the uplink, and reference signal in the uplinks are arranged. It is possible to arrange demodulation reference signals for the data channels in the uplink in areas in which the data channels in the uplink and the control channels in the uplink are arranged. It is possible to arrange random access channels in areas in which the data channels in the uplink are arranged. The first base station device and the second base station devices of FIG. 1 map the various channels and signals onto resource elements based on the uplink transmission format of FIG. 3.

For example, in LTE-A, it is possible to use a Physical Uplink Shared CHannel (PUSCH) as the data channel in the uplink. It is possible to use a Physical Uplink Control CHannel (PUCCH) as the control channel in the uplink. It is possible to use a Sounding Reference Signal (SRS) as the reference signal in the uplink. It is possible to use a Physical Random Access CHannel (PRACH) as the random access channel. It is possible to use a DeModulation Reference Signal (DMRS) as the demodulation reference signal.

According to the transmission frame formats of the first base station device and the second base station device in FIGS. 2 and 3, in the second base station device in the downlink, it is possible to omit the mapping of the broadcast channels, the primary synchronization signals, the secondary synchronization signals, and the cell specific reference signals in the downlink. Therefore, it is possible to allocate a large amount of radio resources for data transmission in a plurality of second base station devices which are arranged to overlap with the cell of the first base station device, and thus it is possible to improve the utilization efficiency of the radio resources.

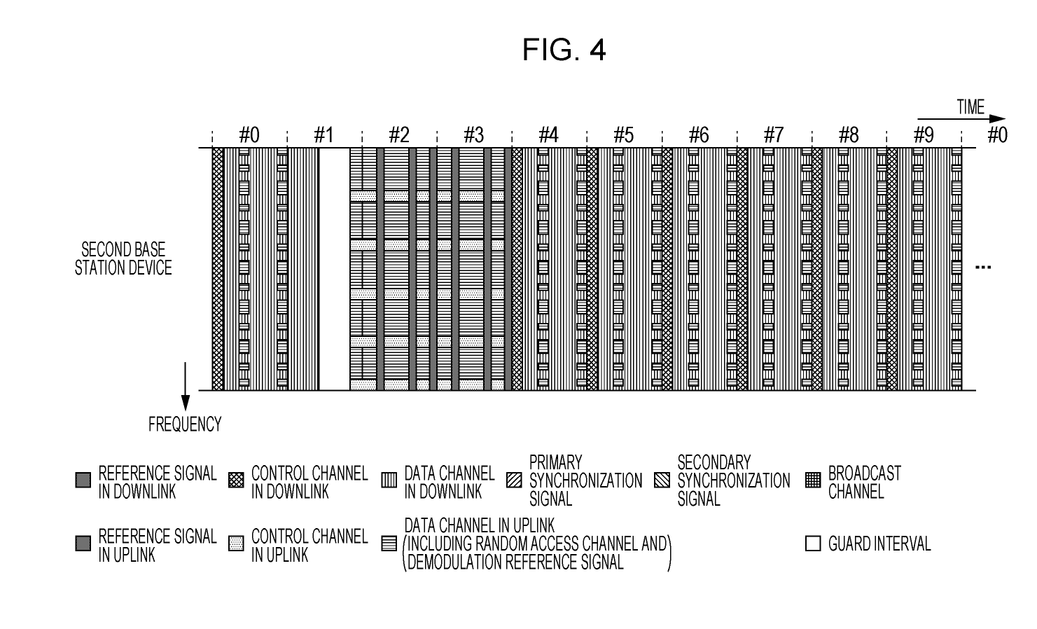

FIG. 4 illustrates another aspect of the transmission frame format of the communication system according to the first embodiment. FIG. 4 illustrates a case in which the second base station device performs communication with the terminal device, which is connected to the second base station device, using Time Division Duplex (TDD) in the uplink and the downlink. In FIG. 4, a single transmission frame format includes 10 sub-frames (#0 to #9). In addition, a sub-frame includes a plurality of OFDM symbols. For example, when the terminal device is connected to the first base station device, the resource mapping is performed on the various channels according to the upper stage of FIG. 2 and the downlink and the uplink transmission formats of FIG. 3. When the terminal device is connected to the second base station device, the resource mapping is performed on the various channels according to the transmission format of FIG. 4.

In the format of FIG. 4, sub-frame indexes #0 and #4 to #9 indicate sub-frames onto which signals in the downlink are mapped. Sub-frame indexes #3 and #4 indicate sub-frames onto which signals in the uplink are mapped. A sub-frame index #2 indicates a sub-frame (also called a special sub-frame) which has a guard interval in order to prevent interference between uplink signals and downlink signals from occurring when the uplink is switched to the downlink.

In the sub-frames, onto which the downlink signals are mapped, of the transmission frame format of FIG. 4, the data channels in the downlink, the control channels in the downlink, and the user specific reference signals in the downlink are arranged. The second base station device performs the resource mapping on the various channels and the signals in the downlink according to the format of FIG. 4, similarly to the description of the lower stage of FIG. 2.

According to the transmission frame format of the second base station device of FIG. 4, it is possible to omit the mapping of the broadcast channels, the primary synchronization signals, the secondary synchronization signals, and the cell specific reference signals in the downlink in the second base station device. Therefore, it is possible to allocate a large amount of radio resources for data transmission in a plurality of second base station devices which are arranged to overlap with the cell of the first base station device, and thus it is possible to improve the utilization efficiency of the radio resources. Further, it is possible to map the various signals onto the resources based on a transmission scheme (FDD or TDD) according to the communication environment (the magnitude of the transmission power or the like) of the first base station device and the second base station devices.

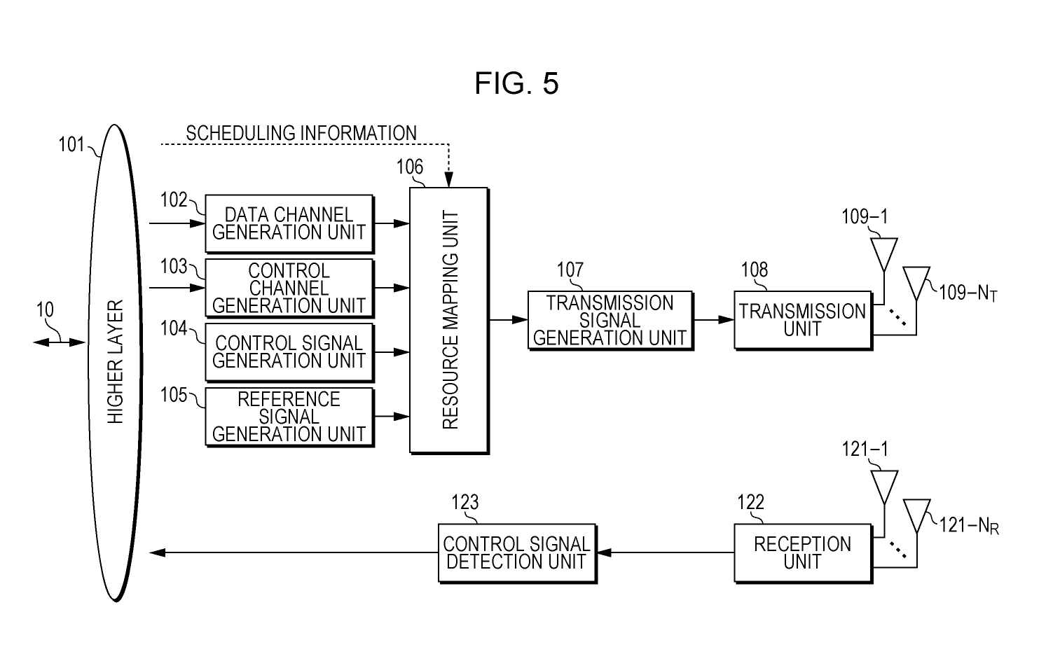

FIG. 5 is a block diagram illustrating the first base station device according to the first embodiment.

The first base station device includes a higher layer 101, a data channel generation unit 102, a control channel generation unit 103, a control signal generation unit 104, a reference signal generation unit 105, a resource mapping unit 106, a transmission signal generation unit 107, a transmission unit 108, transmit antenna units 109-1 to 109-N_{T}, receive antenna units 121-1 to 121-N_{R}, a reception unit 122, and a control signal detection unit 123. N_{T} indicates the number of transmit antennas, and N_{R} indicates the number of receive antennas. In addition, the higher layer 101 is connected to the second base station devices through a backhaul line 10. Meanwhile, when some or the entirety of the first base station device are made of chips and form an integrated circuit, the first base station device includes a chip control circuit (not shown in the drawing) which controls respective functional blocks.

The first base station device receives signals (uplink signal), which are transmitted by the terminal device 200, through the receive antenna units 121-x (x=1, . . . , N_{R}). The uplink signals include the data channels, the control channels, and the reference signals in the uplink.

The data channels in the uplink are used to transmit user data in the uplink. The data, which is transmitted through the data channels in the uplink, includes signals (Channel Statement Information) which indicate neighboring base station measurement results. The data, which is transmitted through the data channels in the uplink, includes signals (Channel Quality Indicator) which notify downlink reception qualities and downlink scheduling allocation request signals. For example, in LTE-A, it is possible to use an uplink shared channel (Physical Uplink Shared Channel (PUSCH)) as the data channels in the uplink. It is possible to use measurement reports or the like as the neighboring base station measurement results in LTE-A.

The control channels in the uplink are used to transmit ACK/NACK to the data channels in the downlink, the downlink reception qualities, and the scheduling allocation request signals. The first base station device can receive the signals (Channel Statement Information) which indicate the neighboring base station measurement results, the signals which notify the downlink reception qualities, and the downlink scheduling allocation request signals through the control channels in the uplink.

The random access channels are used when the terminal device establishes connection with cells through initial access, handover and the like. The reference signal in the uplink is used to measure the reception qualities which are necessary to apply frequency scheduling.

The demodulation reference signals are used to estimate uplink channels, to synchronize symbol timing, and to measure the reception qualities. The demodulation reference signals are multiplexed in the data channels in the uplink or the control channels in the uplink.

The reception unit 122 performs down-conversion (radio frequency conversion) on signals, which are received by the antennas 121, into a frequency band in which it is possible to perform a digital signal process such as a signal detection process, performs a filtering process of removing spuriousness, and performs conversion (Analog to Digital conversion) on signals, which are acquired through the filtering process, from analog signals into digital signals.

The control signal detection unit 123 performs a demodulation process, a decoding process, and the like on the signals which are output by the reception unit 122. Therefore, it is possible to acquire the above-described various signals (the data channels in the uplink, the control channels in the uplink, the reference signal in the uplink, and the like) from the uplink signals.

The higher layer 101 acquires the signals for notifying the downlink reception qualities and the scheduling allocation request signals from the signals which are output by the control signal detection unit 123. The higher layer 101 performs scheduling on the data channels, the control channels, the control signals and the reference signals in the downlink based on the signals for notifying the downlink reception qualities, the scheduling allocation request signals, and the transmission frame formats (FIGS. 2 and 3). The scheduling means determining the resource elements onto which the data channels and/or the control channels and/or the reference signals are mapped.

The higher layer 101 acquires the neighboring base station measurement results from the signals which are output by the control signal detection unit 123. The higher layer 101 determines a base station device (target base station device), which is the subsequent connection destination of the terminal device, using the neighboring base station measurement results and the other signals which are relevant to radio resource management. The higher layer 101 requests (performs a connection request) the target base station device to determine whether or not connection is possible through the backhaul line 10.

The higher layer 101 acquires whether or not connection is possible and the system information of the target base station device from the target base station device, which is requested to be connected, through the backhaul line 10. The system information includes information relevant to the transmission power of the target base station device. It is possible to set the information relevant to the transmission power to the maximum transmission power of the target base station device.

The system information includes broadcast information such as the number of transmit antennas (antenna ports), the system bandwidth, and the system frame number of the target base station device. For example, in LTE-A, it is possible to use a Master Information Block (MIB) and a System Information Block (SIB). In addition, there is a case in which the number of receive antennas of the target base station device is included in the system information.

The higher layer 101 can hold the pieces of system information, such as information relevant to the transmission power, the number of transmit antennas, the system bandwidth, and the system frame number, which are notified from the target base station device.

The higher layer 101 notifies the target base station device of the terminal information of the connected terminal device and undelivered packets through the backhaul line 10.

The higher layer 101 generates information data (transport blocks and code words) for the terminal device, and outputs the generated information data to the data channel generation unit 102. It is possible to establish the information data in units in which an error correction encoding process is performed. In addition, it is possible to establish the information data in units in which retransmission control, such as Hybrid Automatic Repeat reQuest (HARQ), is performed. Meanwhile, the higher layer is a hierarchy, which has a higher function than that of a physical layer, of the hierarchy of communication functions defined in the OSI reference model, and includes, for example, a data link layer, a network layer, or the like.

The higher layer 101 can cause the information data to include a signal (neighboring base station measurement control) of requesting the terminal device to measure the communication qualities between neighboring base station devices and the terminal device. The neighboring base station measurement control can include a cell ID of a target base station candidate which is notified by the higher layer 101.

The higher layer 101 can cause the information data to include information for instructing connection to the target base station device (to instruct a connection destination). It is possible for the information for instructing the connection destination to include the cell ID of the target base station device.

The higher layer 101 can cause the information data to include the target base station recognition information. Information relevant to the transmission power of the target base station device, which is notified from the higher layer 101, can be used as the target base station recognition information.

The higher layer 101 can cause the information data to include information of the base station device (target base station device) which is the subsequent connection destination of the terminal device connected to the first base station device. For example, the cell ID of the target base station device is notified. In addition, the higher layer 101 can cause the information data to include the system information such as the number of transmit antennas, the system bandwidth, and the system frame number.

When the target base station device is the second base station device (low-power base station device), the higher layer 101 can cause the information relevant to the transmission power of the target base station device to be included in the information data. Information relevant to the transmission power of the target base station device, which is acquired through the backhaul line 10, can be used as the target base station recognition information. The higher layer 101 can cause the information relevant to the transmission power of the target base station device to be included in the information data only when the target base station device is the second base station device. The higher layer 101 may cause the information relevant to the transmission power of the target base station device to be included in the information data only when the target base station device has different transmission power from the transmission power of the base station device. The higher layer 101 may cause the information relevant to the transmission power of the target base station device to be included in the information data only when the target base station device has less transmission power than the transmission power of the base station device.

The higher layer can cause the information data to include information such as the number of transmit antennas, the system bandwidth, the system frame number, the broadcast information of the target base station device, and the synchronization timing (the frame synchronization or the symbol synchronization) between the second base station device and the terminal device. When the target base station device is the second base station device, the higher layer may cause the information data to include information such as the broadcast information of the target base station device, which is notified by the higher layer 101, and the synchronization timing (the frame synchronization or the symbol synchronization) between the second base station device and the terminal device. For example, the first base station device can notify the synchronization timing of the second base station device based on the synchronization timing of the first base station device.

When the higher layer 101 notifies the neighboring base station measurement control, the connection destination instruction, the target base station recognition information, the system information (information such as the number of transmit antennas, system bandwidth, the system frame number, the broadcast information of the target base station device, and the synchronization timing between the second base station device and the terminal device) using the downlink control data, the higher layer 101 can notify the control channel generation unit 103 of the pieces of information. When the target base station device is the second base station device (low-power base station device), the higher layer 101 may notify the control channel generation unit 103 of the pieces of the information.

The data channel generation unit 102 (a data channel area allocation unit, a data channel mapping unit, or a common channel generation unit) performs adaption control on the information data which is output by the higher layer 101, and generates data channels (common channels, shared channels, Physical Downlink Shared CHannels (PDSCH)) for the terminal. More specifically, in the adaption control of the data channel generation unit 102, an encoding process in order to perform error correction encoding, a scramble process in order to apply a unique scramble code to the terminal, a modulation process such as a multi-level modulation method (BPSK, QPSK, or QAM), a layer mapping process in order to perform spatial multiplex, such as MIMO, and the like are performed. Here, in a layer mapping process of the data channel generation unit 102, mapping is performed on one or more layers (streams) based on the number of ranks which are set to the terminal.

The control channel generation unit 103 generates the control channels in the downlink. The control channel generation unit 103 performs a data modulation process and a precoding process on the control channels in the downlink.

The control channels in the downlink include Downlink Control Information (DCI). The downlink control information includes information relevant to the resource allocation of the data channels, a Modulation and Coding Scheme (MCS), information relevant to the number of space multiplexes (for example, Rank Indicator (RI)), information relevant to scrambling identities, information relevant to a reference signal sequence identity (also called a base sequence identity, a base sequence identifier, or a base sequence index), or the like.

When the neighboring base station measurement control is input from the higher layer 101, the control channel generation unit 103 can cause the control channels in the downlink to include the neighboring base station measurement control. It is possible to cause the neighboring base station measurement control to include the cell ID of the target base station candidate which is notified by the higher layer 101.

The control channel generation unit 103 can cause the control channels in the downlink to include information for instructing to connect to the target base station device which is notified by the higher layer 101. It is possible for the information for instructing the connection to include the cell ID of the target base station device.

The control channel generation unit 103 can cause the control channels in the downlink to include the target base station recognition information. It is possible to use the target base station recognition information as the information relevant to the transmission power of the target base station device which is notified by the higher layer 101. The control channel generation unit 103 can cause the information relevant to the transmission power of the target base station device to be included in the control channels in the downlink only when the target base station device is the second base station device. The control channel generation unit 103 may cause the information relevant to the transmission power of the target base station device to be included in the control channels in the downlink only when the target base station device has transmission power different from that of the base station device. The control channel generation unit 103 may cause the information relevant to the transmission power of the target base station device to be included in the control channels in the downlink only when the target base station device has lower transmission power than the base station device.

The control channel generation unit 103 can cause the control channels in the downlink to include the system information such as the number of transmit antennas, the system bandwidth, or the system frame number of the target base station device which is notified by the higher layer 101. When the target base station device is the second base station device, the control channel generation unit 103 can cause the control channel in the downlink to include information such as the broadcast information of the target base station device which is notified by the higher layer 101 and the synchronization timing (frame synchronization or symbol synchronization) between the second base station device and the terminal device.

The control channel generation unit 103 can generate Enhanced-PDCCH (E-PDCCH) in LTE-A as the control channels in the downlink. The control channel generation unit 103 can cause the E-PDCCH to include the target base station recognition information. The control channel generation unit 103 can cause the E-PDCCH to include the system information. The control channel generation unit 103 generates the broadcast information of the first base station device (for example, Physical Broadcast CHannel (PBCH) in LTE).

The control signal generation unit 104 generates synchronization signals for establishing and following the synchronization, such as the symbol synchronization or the frame synchronization, between the first base station device and the terminal device. In the transmission frame format of FIG. 2, the control signal generation unit 104 generates the primary synchronization signals and the secondary synchronization signals. For example, it is possible to apply a Zadoff Chu sequence, an M sequence, or the like as a synchronization signal sequence.

The reference signal generation unit 105 generates the reference signals (pilot signals), and outputs the reference signals to the resource mapping unit 106. In the transmission frame format of FIG. 2, the reference signal generation unit 105 generates the cell specific reference signals in the downlink and the user specific reference signals in the downlink.

The resource mapping unit 106 maps the data channels which are output by the data channel generation unit 102, the control channels which are output by the control channel generation unit 103, the control signals which are output by the control signal generation unit 104, and the reference signals which are output by the reference signal generation unit 105 onto the resource elements based on the resource allocation information (scheduling information) of the data channels, the control channels, the control signals, and the reference signals which are notified by the higher layer 101. The scheduling information is information based on the transmission frame format (FIG. 2).

The transmission signal generation unit 107 generates OFDM signals. More specifically, the transmission signal generation unit 107 converts frequency domain signals, which are input from the resource mapping unit 106, into time domain signals through Inverse Discrete Fourier Transform (IDFT) or Inverse First Fourier Transform (IFFT). The transmission signal generation unit 107 generates the OFDM symbols by adding Guard Intervals (GI) to the time domain signals (called valid symbols). The GI is an interval which is added to prevent the OFDM symbols in anteroposterior time from interfering in each other. The GI includes, for example, Cyclic Prefix (CP). For example, the transmission signal generation unit 107 prepositions the copies of some sections of the latter half of the valid symbols as GIs in the valid symbols. Therefore, the valid symbols, in which the GIs are prepositioned, are the OFDM symbols.

The transmission unit 108 generates analog signals by performing Digital-to-Analog (D/A) conversion on the OFDM symbols. The transmission unit 108 generates band limiting signals by band limiting the generated analog signals through a filtering process. The transmission unit 108 up converts the generated band limiting signals into a radio frequency band, and outputs the resulting signals to the transmit antenna units 109-1 to 109-N_{T}.

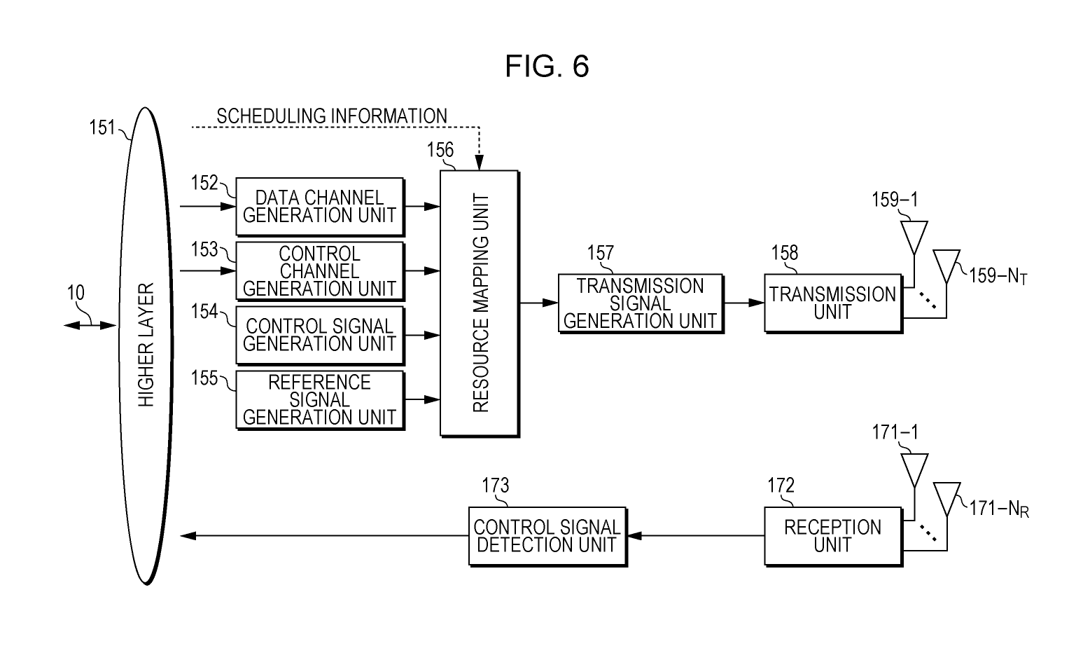

FIG. 6 is a block diagram illustrating the second base station device according to the first embodiment. The second base station device includes a higher layer 151, a data channel generation unit 152, a control channel generation unit 153, a control signal generation unit 154, a reference signal generation unit 155, a resource mapping unit 156, a transmission signal generation unit 157, a transmission unit 158, transmit antenna units 159-1 to 159-N_{T}, receive antenna units 171-1 to 171-N_{R}, a reception unit 172, and a control signal detection unit 173. Meanwhile, some or the entirety of the second base station device are made of chips and form an integrated circuit, and the second base station device includes a chip control circuit (not shown in the drawing) which controls respective functional blocks. In addition, the higher layer 151 can be connected to the first base station device and other second base station devices through a backhaul line 10.

The second base station device receives signals (uplink signals), which are transmitted by the terminal device 200, through the receive antenna units 171-x (x=1, . . . , N_{R}). The reception unit 172 performs down-conversion (radio frequency conversion) on signals, which are received by the antenna 171-x, into a frequency band in which it is possible to perform a digital signal process such as a signal detection process, performs a filtering process of removing spuriousness, and performs conversion (Analog to Digital conversion) on signals, which are acquired through the filtering process, from analog signals into digital signals. The control signal detection unit 173 performs a demodulation process, a decoding process, and the like on signals which are output by the reception unit 172. Therefore, it is possible to acquire various uplink signals (data channels in the uplink, control channels in the uplink, and the like) which are included in the uplink signal.

The higher layer 151 has a function of determining whether or not to permit connection in response to a connection request from the first base station device through the backhaul line 10.

The higher layer 151 can generate the system information of the base station device (the second base station device). The higher layer 151 can cause the system information to include information relevant to the transmission power of the base station device. In addition, the higher layer 151 can cause the system information to include the number of transmit antennas, the system bandwidth, the system frame number, and the broadcast information of the base station device. For example, in LTE-A, it is possible to use MIB or SIB. In addition, the higher layer 151 can cause the system information to include the number of receive antennas of the base station device. The higher layer 151 can notify the first base station device of the connection permission and the system information through the backhaul line 10.

The higher layer 151 can acquire the terminal information of the terminal device, which is connected to the base station device, and undelivered packets from the first base station device through the backhaul line 10. The higher layer 151 generates information data (transport blocks and code words) for the terminal device, and outputs the generated information data to the data channel generation unit 152. The higher layer 151 notifies the control channel generation unit 153 of downlink control information (the radio resource allocation, the MCS, or the like) which is used to generate the control channels.

The data channel generation unit 152 performs adaption control on the information data, which is output by the higher layer 151, and generates the data channels for the terminal.

The control channel generation unit 153 generates control channels in the downlink. The control channels in the downlink include Downlink Control Information (DCI). The downlink control information includes information relevant to the resource allocation of the data channels, information relevant to the MCS, information relevant to the number of space multiplexes (RI), and the like. The control channel generation unit 153 performs a data modulation process and a precoding process on the control channels in the downlink.

When synchronization signals for establishing and following the synchronization between the second base station device and the terminal device, such as the symbol synchronization and the frame synchronization, are generated, the second base station device includes the control signal generation unit 154. The reference signal generation unit 155 generates the user specific reference signals (pilot signals) and outputs the reference signals to the resource mapping unit 156.

The resource mapping unit 156 maps the data channels which are output by the data channel generation unit 152, the control channels which are output by the control channel generation unit 153, and the reference signals which are output by the reference signal generation unit 155 onto the resource elements based on the resource allocation (scheduling information) of the data channels, the control channels, the control signals, and the reference signals which are notified by the higher layer 151. The scheduling information is information based on the transmission frame format (the lower stage of FIG. 2 or FIG. 3).

The transmission signal generation unit 157 generates OFDM signals from the signals which are input from the resource mapping unit 156. More specifically, the transmission signal generation unit 157 converts the frequency domain signals, which are input from the resource mapping unit 156, into time domain signals (valid symbols) through the Discrete Fourier Transform. The transmission signal generation unit 157 generates the OFDM symbols by adding GI to the time domain signals.

It is possible to cause the lengths of the GIs of the OFDM signals, which are transmitted and received by the second base station device, to be different from the lengths of the GIs of the OFDM signals, which are transmitted and received by the first base station device. With regard to the GI, the transmission signal generation unit 157 of the second base station device adds GI, which has lengths that are different from the lengths of the GIs added by the transmission signal generation unit 107 of the first base station device, to the valid symbols.

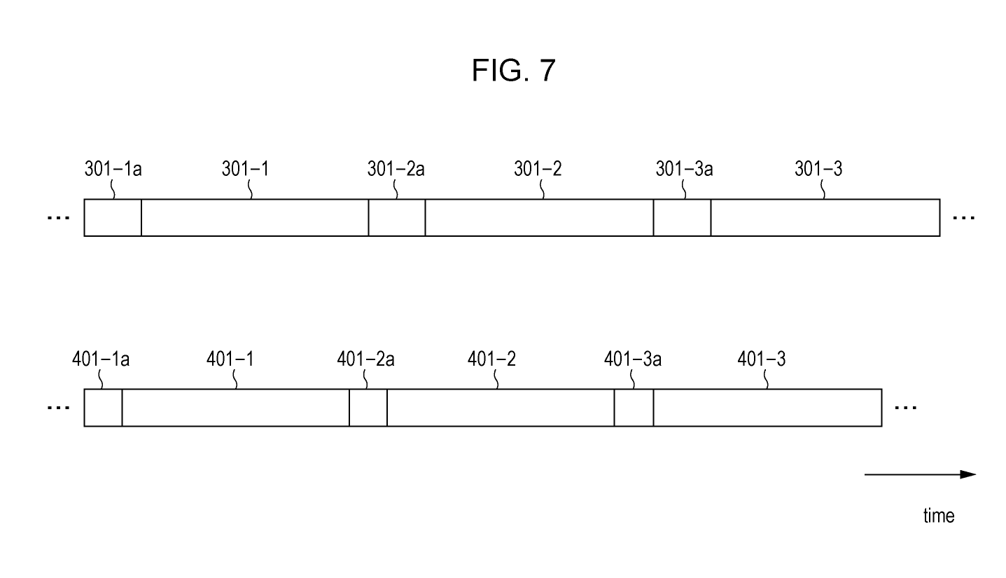

FIG. 7 is a schematic diagram illustrating the transmission symbol format according to the first embodiment. An upper stage of FIG. 7 illustrates a first OFDM symbol which is output by the transmission signal generation unit 107 of the first base station device. The first OFDM symbol includes a first valid symbol 301-y (y indicates the number of OFDM symbols in the frame format which is transmitted and received by the first base station device) and a first guard interval 301-ya. The lower stage of FIG. 7 illustrates a second OFDM symbol which is output by the transmission signal generation unit 157 of the second base station device. The second OFDM symbol includes a second valid symbol 401-z (z indicates the number of OFDM symbols in the frame format which is transmitted and received by the first base station device) and a second guard interval 401-za. FIG. 7 illustrates a case in which the second base station device makes setting such that the length of the second guard interval 401-za is shorter than the length of the first guard interval 301-ya.

According to the OFDM symbols of FIG. 7, the second base station device can set the lengths of the GIs according to the transmission power and the usable frequency band of the base station device. Therefore, it is possible to improve the transmission efficiency with the terminal device which communicates with the second base station device.

The transmission unit 158 generates analog signals by performing D/A conversion on the OFDM symbols. The transmission unit 158 generates band limiting signals by band limiting the generated analog signals through a filtering process. The transmission unit 158 up converts the generated band limiting signals into a radio frequency band, and outputs the resulting signals to the transmit antenna units 159-1 to 159-N_{T}.

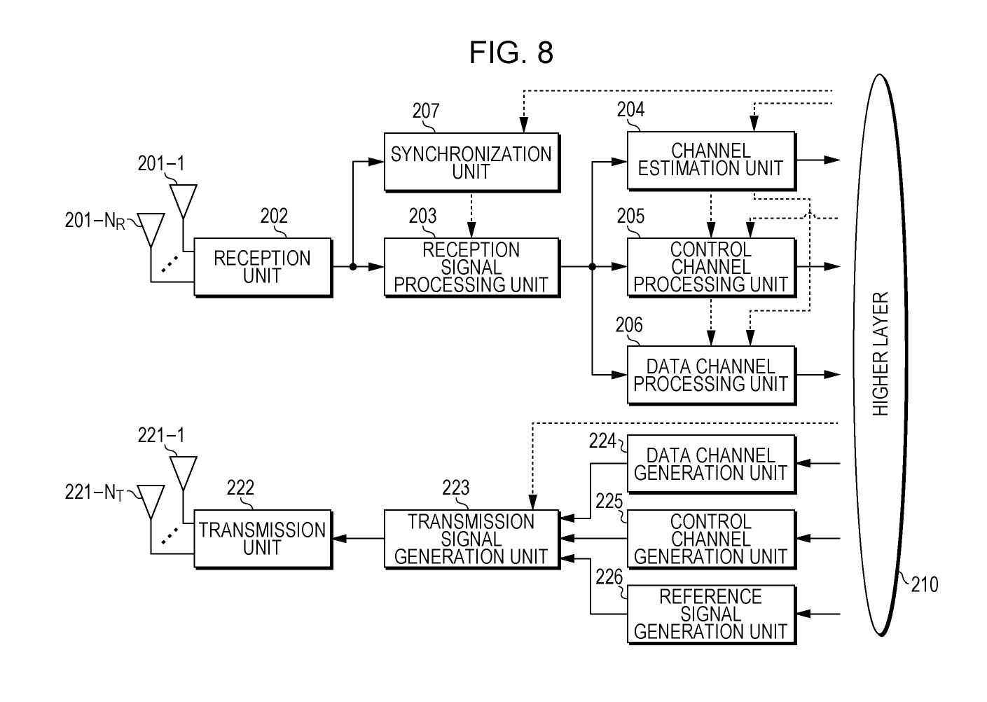

FIG. 8 is a block diagram illustrating the terminal device according to the first embodiment. The terminal device includes receive antenna units 201-1 to 201-N_{R}, a reception unit 202, a reception signal processing unit 203, a channel estimation unit 204, a control channel processing unit 205, a data channel processing unit 206, a synchronization unit 207, a higher layer 210, transmit antenna units 221-1 to 221-N_{T}, a transmission unit 222, a transmission signal generation unit 223, a data channel generation unit 224, a control channel generation unit 225, and a reference signal generation unit 226. Meanwhile, when some or the entirety of the terminal device are made of chips and form an integrated circuit, the terminal device includes a chip control circuit (not shown in the drawing) which controls respective functional blocks.

The receive antenna units 201-1 to 201-N_{R} receive carrier band OFDM signals, which are propagated from the first base station device or the second base station device, as radio waves, and outputs the received carrier band OFDM signals to the reception unit 202. When the frequency bands of the transmission signals of the first base station device are different from those of the second base station device, the terminal device can include the receive antenna unit 201-1 to 201-N_{R} which can be applicable for the respective frequency bands.

The reception unit 202 down converts the OFDM signals, which are input from the receive antenna units 201-1 to 201-N_{R}, into frequency bands in which it is possible to perform the digital signal process, and removes unnecessary components (spuriousness) by performing the filtering process on the signals acquired through the down conversion. The reception unit 202 performs Analog-to-Digital (A/D) conversion on the signals, on which the filtering process is performed, from analog signals to digital signals, and outputs the digital signals, which are acquired through the conversion, to the reception signal processing unit 203 and the synchronization unit 207.

When the reception unit 202 receives the signals which are transmitted by the first base station device, the respective channels, which are included in the reception signals, are mapped based on the format of the upper stage of FIG. 2. When the reception unit 202 receives the signals which are transmitted by the second base station device, the respective channels, which are included in the reception signals, are mapped based on the format of the lower stage of FIG. 2 or the format of FIG. 4.

The synchronization unit 207 establishes the symbol synchronization and the frame synchronization for the signals, which are transmitted from the first base station device, using synchronization signals (for example, PSS or SSS) which are included in the signals input from the reception unit 202.

The synchronization unit 207 can acquire signals for acquiring synchronization with the target base station device (second base station device) from the higher layer 210. The synchronization unit 207 can acquire the frame synchronization and/or the symbol synchronization based on the signals for acquiring synchronization with the target base station device. When already-known signals are included in the control channels included in the signals which are input from the reception unit 202, the synchronization unit 207 can use the already-known signals for synchronization acquisition.

The reception signal processing unit 203 performs a demodulation process for OFDM modulation on the digital signals which are input from the reception unit 202 according to the symbol synchronization timing and the frame synchronization timing which are input from the synchronization unit 207. More specifically, the reception signal processing unit 203 removes the lengths of the GIs and performs a DFT (IFFT) process.

The channel estimation unit 204 performs channel estimation using the downlink reference signals included in the signals which are output by the reception signal processing unit 203. The channel estimation unit 204 can perform the channel estimation between the terminal device 200 and the first base station device using the cell specific reference signals in the downlink (for example, CRS) or the user specific reference signals in the downlink (for example, DMRS). The channel estimation unit 204 can perform the channel estimation between the terminal device 200 and the first base station device using the user specific reference signals in the downlink (for example, DMRS). A channel estimation value is input to the control channel processing unit 205, the data channel processing unit 206, and the higher layer 210. The channel estimation value includes, for example, a transmission function, an impulse response, or the like.

The channel estimation unit 204 can measure the channel quality (channel state measurement) between the terminal device and the second base station device using the downlink reference signals included in the signals which are output by the reception signal processing unit 203. For example, the channel quality corresponds to reception power, interference power, reception SNR, reception SINR, or the like.

The channel estimation unit 204 can perform the channel state measurement between the terminal device 200 and the first base station device using the cell specific reference signals in the downlink (for example, CRS) or the user specific reference signals in the downlink (for example, CSI-RS). The channel estimation unit 204 can acquire the arrangement information of the cell specific reference signals in the downlink and the user specific reference signals in the downlink from the higher layer 210. The arrangement information of the cell specific reference signals in the downlink and the user specific reference signals in the downlink are calculated based on the cell IDs. The cell IDs may be calculated from the synchronization sequence in which the synchronization unit 207 establishes synchronization.

The channel estimation unit 204 performs the channel state measurement between the terminal device 200 and the second base station device using the user specific reference signals in the downlink (for example, CSI-RS). The channel estimation unit 204 can understand the arrangement of the user specific reference signals in the downlink based on information relevant to the neighboring base station devices which are notified by the higher layer 210. The information relevant to the neighboring base station devices can be used as the cell IDs of the neighboring base station devices. Meanwhile, the arrangements of the cell specific reference signals in the downlink and the user specific reference signals in the downlink are associated with the cell IDs.

The control channel processing unit 205 detects (performs channel compensation, the demodulation process, and the decoding process based on the channel estimation value) the control channels in the downlink (for example, PDCCH) included in the signals which are output by the reception signal processing unit 203. When the control channel processing unit 205 extracts the pieces of control information of the MCS, a pre-coding matrix, and the number of layers, which are given to the data channels of the first base station device or the second base station device which are included in the control channels in the downlink transmitted by the first base station device or the second base station device, the control channel processing unit 205 notifies the data channel processing unit 206 of the pieces of control information. These pieces of control information are used to detect the data channels in the downlink.

The data channel processing unit 206 detects the data channels in the downlink which are included in the signals output by the reception signal processing unit 203 (performs channel compensation, the demodulation process, and the decoding process based on the channel estimation values), and outputs the data channels in the downlink to the higher layer 210.

When the higher layer 210 notifies the base station device of the channel state measurement results (neighboring base station measurement results) between the terminal device and the neighboring base station device, which are input from the channel estimation unit 204, using the data channels in the uplink, the higher layer 210 can output the neighboring base station measurement results to the data channel generation unit 224. When the higher layer 210 notifies the base station device of the neighboring base station measurement results using the control channels in the uplink, the higher layer 210 can output the neighboring base station measurement results to the control channel generation unit 225.

The higher layer 210 extracts the information data from the data channels in the downlink input from the data channel processing unit 206. When the information data includes signals relevant to the neighboring base station measurement control, the higher layer 210 extracts the signals relevant to the neighboring base station measurement control. In the same manner, the higher layer 210 extracts signals relevant to the connection destination instruction included in the information data. In the same manner, the higher layer 210 extracts signals relevant to the target base station recognition information included in the information data (information relevant to the transmission power of the target base station device). The higher layer 210 can recognize whether the target base station device is the first base station device or the second base station device based on the target base station recognition information.

In the same manner, the higher layer 210 extracts system information relevant to the second base station device included in the information data. When the target base station device is the second base station device based on the target base station recognition information, the higher layer 210 may extract the system information relevant to the second base station device included in the information data.

When the control channels in the downlink, which are input from the control channel processing unit 205, include the signals relevant to the neighboring base station measurement control, the higher layer 210 extracts the signals relevant to the neighboring base station measurement control. When the control channels in the downlink, which are input from the control channel processing unit 205, include the signals relevant to the connection destination instruction, the higher layer 210 extracts the signals relevant to the connection destination instruction. When the control channels in the downlink, which are input from the control channel processing unit 205, include the signals relevant to the target base station recognition information, the higher layer 210 extracts the signals. In this case, the higher layer 210 can recognize whether the target base station device is the first base station device or the second base station device based on the target base station recognition information.

When the control channels in the downlink, which are input from the control channel processing unit 205, include pieces of system information relevant to the second base station device, the higher layer 210 extracts the signals. When the target base station device is the second base station device based on the target base station recognition information, the higher layer 210 may extract the pieces of system information relevant to the second base station device, which are included in the control channels in the downlink.

The higher layer 210 extracts the control information of the data channels in the uplink such as the MCS, which is given to the data channels in the uplink included in the control channels in the downlink, or the scheduling allocation.

The higher layer 210 generates the information data for the base station device and outputs the information data to the data channel generation unit 224. When the higher layer 210 notifies the base station device of neighboring base station assumption results using the data channels in the uplink, the higher layer 210 can cause the neighboring base station assumption results to be included in the information data. When the higher layer 210 notifies the base station device of the neighboring base station assumption results using the control channels in the uplink, the higher layer 210 notifies the control channel generation unit 225 of the neighboring base station assumption results.

The data channel generation unit 224 performs the adaption control (error correction encoding, data modulation, or the like) on the information data which is output by the higher layer 210, and generates the data channels (for example, Physical Uplink Shared CHannel (PUSCH)) for the base station device.

The control channel generation unit 225 generates the control channels in the uplink. When the neighboring base station assumption results are input from the higher layer 210, the neighboring base station assumption results are included in the control channels in the uplink. In addition, the control channel generation unit 225 generates the random access channels which are used to perform synchronization in the uplink. The reference signal generation unit 226 generates the reference signals (for example, DMRS and SRS) which are used to estimate the uplink channels and to measure the reception qualities which are necessary to apply the frequency scheduling.

The transmission signal generation unit 223 maps the data channels in the uplink, the control channels in the uplink, the random access channels, and the reference signals onto the resources according to the transmission frame format in the uplink (FIG. 3 or FIG. 4), performs the multi-carrier modulation (SC-FDMA, OFDM, or the like), and generates transmission signals in the uplink.

The transmission signal generation unit 223 generates transmission signals for the first base station device based on the format of the OFDM symbols described in the upper stage of FIG. 7. The transmission signal generation unit 223 generates transmission signals for the second base station device based on the format of the OFDM symbols described in the lower stage of FIG. 7.

The signals, which are output by the transmission signal generation unit 223, are up converted into the frequency bands which can be transmitted in the uplink by the transmission unit 222, and are transmitted to the base station device through the transmit antenna units 221-1 to 221-N_{T}.

Subsequently, an operation of connecting the first base station device, the second base station device, and the terminal device in the communication system according to the first embodiment will be described. In FIG. 1, when power is supplied, the terminal 200 performs the cell searching for the base station device to be connected. Here, the terminal 200 searches for the base station device to be connected in the first base station device. The terminal device 200 performs the cell searching using a synchronization sequence (synchronization channel) which is generated based on the cell ID allocated to the first base station device. In addition, the terminal device 200 searches for the base station device to be connected from the first base station device by performing the cell searching for only the frequency band of the first base station device.

After the cell is found, the terminal device 200 receives the selected broadcast channel of the first base station device, and establishes connection with the first base station device. In FIG. 1, the terminal device 200 selects the base station device 100-1 by performing the cell searching and establishes connection. Subsequently, connection switching is performed from the base station device 100-1 into the second base station device.

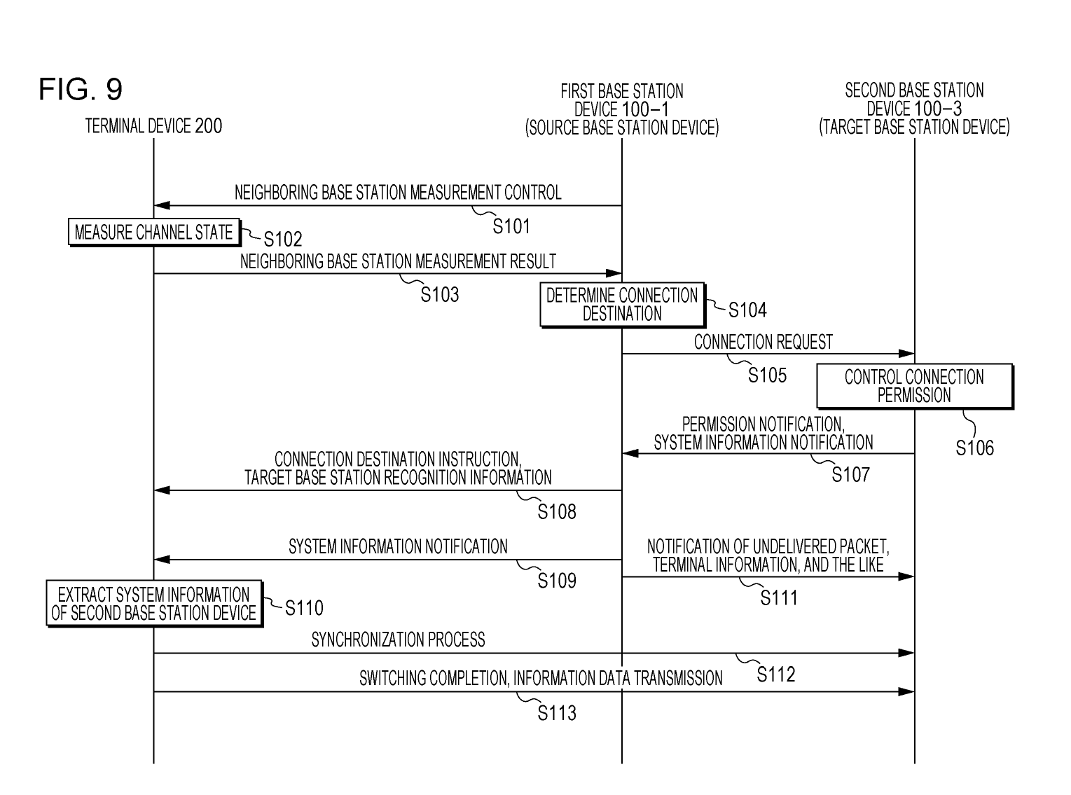

FIG. 9 is a sequence diagram illustrating the connection of the terminal device to the second base station device in the communication system according to the first embodiment. FIG. 9 illustrates a case in which the terminal device, which is connected to the first base station device, switches connection to the second base station device. A source base station device is the base station device of a connection source (first base station device in FIG. 9), and a target base station device is the base station device of a connection destination (second base station device in FIG. 9).

When the terminal device 200 is notified of neighboring base station control by the base station device 100-1 which is the source base station device (S101), the terminal device 200 measures the cannel state between the base station device, which is designated through the notification, and the terminal device (S102). In FIG. 1, the terminal device 200 measures the channel states between the terminal device and the base station devices 100-2 to 100-5. It is possible to use the reference signals, which are transmitted by the respective base station devices, in order to measure the channel state. For example, it is possible to use the CSI-RS in LTE in order to measure the channel. The terminal device 200 notifies the base station device 100-1 of channel state measurement results (neighboring base station measurement results) (S103).

The base station device 100-1 can determine the connection destination (target base station device) based on the neighboring base station measurement results (S104). It is desirable that the source base station device selects a base station device, which has excellent channel quality, as the target base station device. It is possible to determine the channel quality based on reception power, interference power, reception SNR, reception SINR, or the like. Here, it is assumed that the base station device 100-1 selects the second base station device 100-3 as the target base station device.

The base station device 100-1 notifies the base station device 100-3 of a connection request (for example, handover request) through the backhaul line 10 (S105). The base station device 100-3 determines whether or not connection is possible (S106). When connection is possible, the base station device 100-3 makes preparations for connection such as scheduling (S106). The base station 100-3 notifies the base station device 100-1 of the permission (handover request ACK/NACK) and system information (S107). The system information includes information relevant to the transmission power of the base station device 100-3 which is the low-power base station. The system information includes information relevant to the number of transmit antennas, the system bandwidth, the system frame number, the frame timing of the base station device, and symbol timing. There is a case in which the system information includes information which is notified by the MIB.

When the base station device 100-1 receives the permission notification (S107), the base station device 100-1 notifies the base station device 100-3 of the terminal information of the terminal device 200 and undelivered packets.

When the base station device 100-1 receives the permission notification (S107), the base station device 100-1 provides the connection destination instruction for performing connection switching into the base station device 100-3 to the terminal device 200 (S108). Further, the base station device 100-1 notifies the terminal device 200 of the information relevant to the transmission power of the target base station device as the target base station recognition information (S108). The terminal device 200 recognizes whether the target base station device is the first base station device or the second base station device according to the target base station recognition information. As another notification method, when the target base station device is the second base station device, the base station device 100-1 notifies of the information relevant to the transmission power of the target base station device. In this case, the terminal device 200 can recognize that the target base station device is the second base station device when it is possible to acquire the information relevant to the transmission power of the target base station device from a prescribed resource element.

Here, it is assumed that the target base station device (base station device 100-3) is the second base station device. In this case, the base station device 100-1 notifies the terminal device 200 of the system information of the base station device 100-3 (S109). When the terminal device recognizes that the target base station device is the second base station device, the terminal device extracts the system information included in the control channels in the downlink (S110). Here, when the first base station device already maintains the system information, it is possible to omit the notification of the system information in S107. For example, when the first base station device 100-1 selected the second base station device 100-3, to which the connection request (S105) is provided, as the target base station device in the past, it is possible to omit the notification.

When the terminal device 200 receives the connection destination instruction, the target base station recognition information and the system information notification (S108, S109, and S110), the terminal device 200 switches a transmission destination and performs a synchronization process using the random access channels between the terminal device 200 and the base station device 100-3 (S112). Further, the terminal device 200 provides a notification that switching is completed to the base station device 100-3 (notification that the connection is established), and transmits the data channels (information data) (S113).

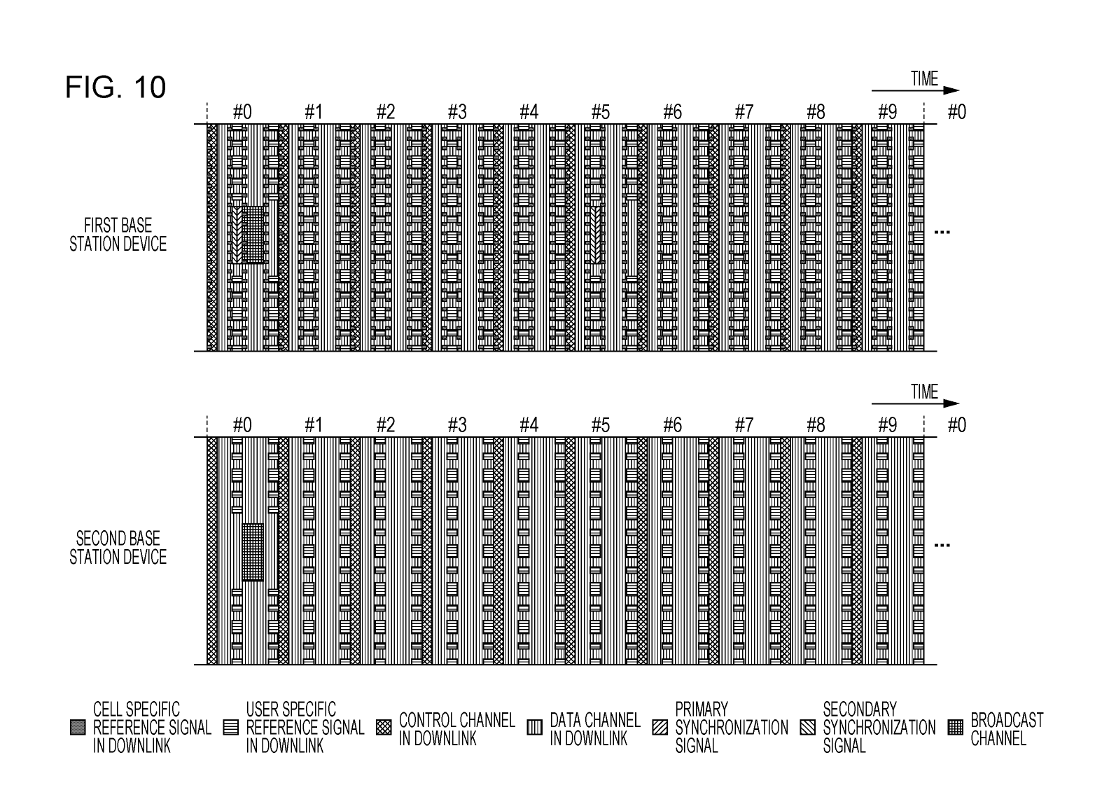

FIG. 10 illustrates another aspect of the transmission frame format of the communication system according to the first embodiment. An upper stage of FIG. 10 illustrates the transmission frame format of the first base station device in the downlink. The upper stage of FIG. 10 illustrates the transmission frame format of FDD in the downlink. The upper stage of FIG. 10 is the same format as that of the upper stage of FIG. 2, and the first base station device maps various channels and signals onto resources similarly to the description of the upper stage of FIG. 2.

The lower stage of FIG. 10 illustrates the transmission frame format of the second base station device. The transmission frame format illustrated in the lower stage of FIG. 10 includes data channels in the downlink, control channels in the downlink, user specific reference signals in the downlink, and broadcast channels. The second base station device maps various channels and signals onto resource elements based on the transmission frame format.

According to the transmission frame formats of the first base station device and the second base station device of FIG. 10, the second base station device can omit the mapping of cell specific reference signals in the downlink, primary synchronization signals, and secondary synchronization signals. Therefore, the plurality of second base station devices, which are arranged to overlap with the cell of the first base station device, can allocate a lot of radio resources for data transmission.

In the transmission frame formats of FIG. 2, FIG. 3, and FIG. 10, it is possible to perform control such that the terminal device is connected to the second base station device only after the terminal device is initially connected to the first base station device. Therefore, in the transmission frame of the second base station device in the lower stage of FIG. 4 and the lower stage of FIG. 5, the second base station device can omit the synchronization signals (primary synchronization signals and the secondary synchronization signals). Therefore, it is possible to improve the utilization efficiency of the radio resources.

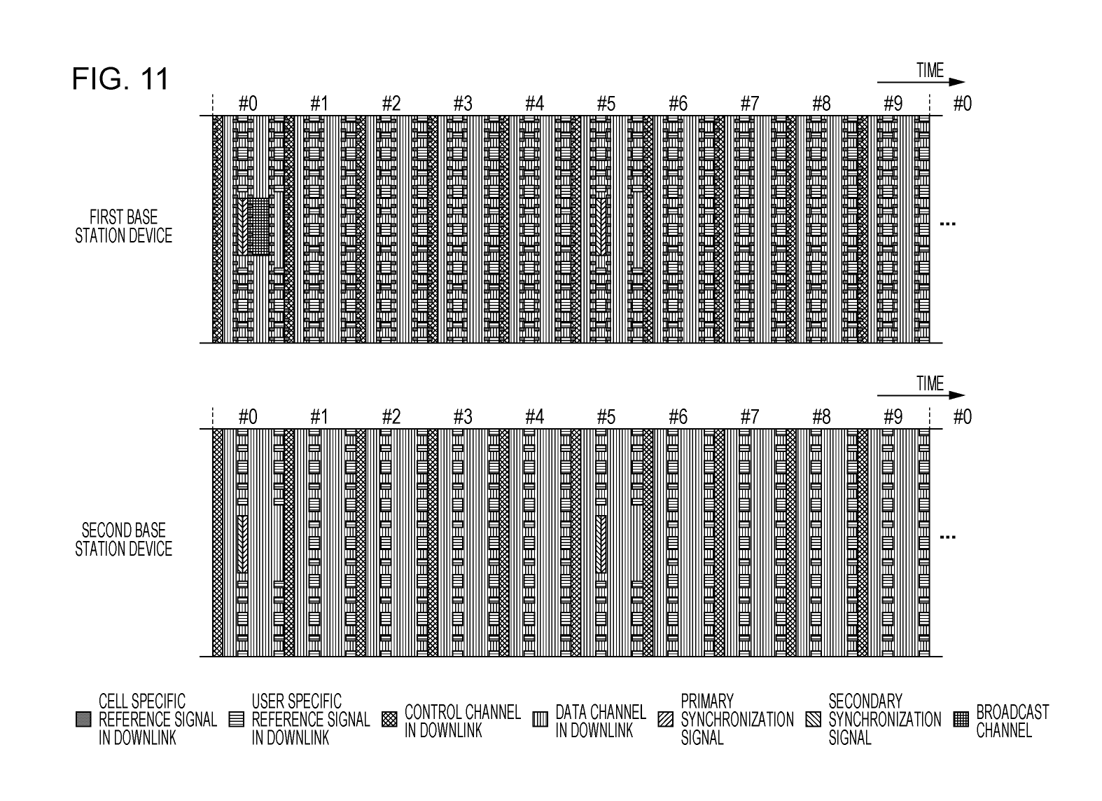

FIG. 11 illustrates another aspect of the transmission frame format of the communication system according to the first embodiment. The upper stage of FIG. 11 illustrates the transmission frame format of the first base station device in the downlink. The upper stage of FIG. 11 illustrates the transmission frame format of the FDD in the downlink. The upper stage of FIG. 11 illustrates the format which is the same as the upper stage of FIG. 2, and the first base station device maps various channels and signals onto resources similarly to the description for the upper state of FIG. 2.

The lower stage of FIG. 11 illustrates the transmission frame format of the second base station device. The transmission frame format of the lower stage of FIG. 11 includes the data channels in the downlink, the control channels in the downlink, the user specific reference signals in the downlink, the primary synchronization signal, and the secondary synchronization signals. The second base station device maps the various channels and signals onto resource elements based on the transmission frame format.

When the first base station device and the second base station device transmit signals to the terminal device based on the transmission frame format of FIG. 11, the control channels in the downlink, which are generated by the control channel generation unit 103 of the first base station device, include at least the broadcast information of the second base station device. In addition, in the transmission format of FIG. 11, the terminal device can follow synchronization using the primary synchronization signals and the secondary synchronization signals in the downlink of the second base station device.

According to the transmission frame format of the first base station device and the second base station device of FIG. 11, it is possible to omit the mapping of the broadcast channels and the cell specific reference signals in the downlink in the second base station device. Therefore, it is possible to allocate a large amount of radio resources for data transmission in the plurality of second base station devices which are arranged to overlap with the cell of the first base station device.

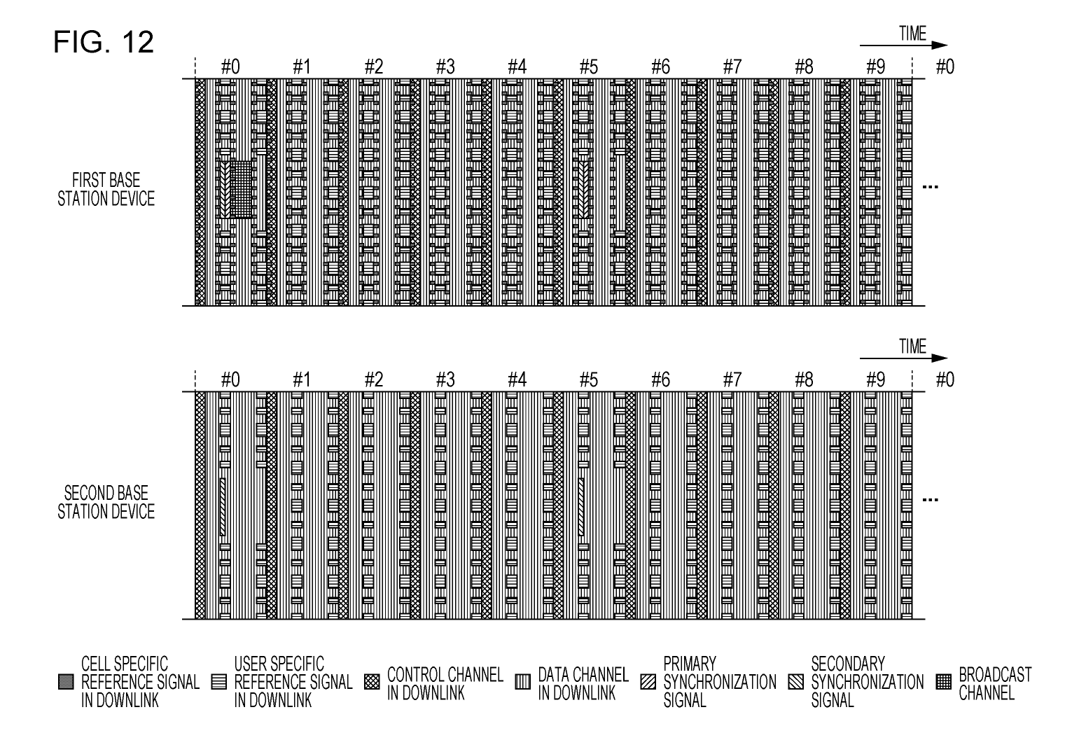

FIG. 12 illustrates another aspect of the transmission frame format of the communication system according to the first embodiment. The upper stage of FIG. 12 illustrates the transmission frame format of the first base station device in the downlink. The upper stage of FIG. 12 illustrates the transmission frame format of the FDD in the downlink. The upper stage of FIG. 12 illustrates a format which is the same as the upper stage of FIG. 2, and the first base station device maps various channels and signals onto resources similarly to the description for the upper state of FIG. 2.

The lower stage of FIG. 12 illustrates the transmission frame format of the second base station device. The transmission frame format of the lower stage of FIG. 12 includes data channels in the downlink, control channels in the downlink, user specific reference signals in the downlink, and secondary synchronization signals. The second base station device maps the various channels and signals onto resource elements based on the transmission frame format. Meanwhile, although the transmission frame format of the lower stage of FIG. 12 includes only the secondary synchronization signals, the transmission frame format of the lower stage of FIG. 12 may include any of the primary synchronization signals or the secondary synchronization signal.

When the first base station device and the second base station device transmit signals to the terminal device based on the transmission frame format of FIG. 12, the first base station device causes the control channels in the downlink, which are generated by the control channel generation unit 103, to include at least the broadcast information of the second base station device. In addition, in the transmission format of FIG. 12, the terminal device can follow synchronization using the secondary synchronization signals in the downlink of the second base station device.

In addition, in the transmission frame format of FIG. 12, the terminal device can classify the first base station device and the second base station device by allocating different synchronization channels in the first base station device and the second base station device. In this case, the terminal device performs cell researching on the base station device to be connected by allocating resources of synchronization channels in the first base station device.

According to the transmission frame formats of the first base station device and the second base station device of FIG. 12, it is possible to omit mapping of the broadcast channels, the cell specific reference signals in the downlink, and some synchronization signals in the second base station device. Therefore, it is possible to allocate a large amount of radio resources for data transmission in the plurality of second base station devices which are arranged to overlap with the cell of the first base station device.

According to the first embodiment, in the communication system which includes the first base station device, at least one second base station device which has lower transmission power than the first base station device, and the terminal device which is connected to the first base station device or the second base station device, the terminal device can recognize whether or not the target base station device is the second base station device according to the information relevant to the transmission power, and the terminal device can acquire the control information of the second base station device from the first base station device. Therefore, in the system, the second base station device (low-power base station device) can reduce the control information to be transmitted to the terminal device. Therefore, it is possible to efficiently control connecting and switching over for the base station device and the terminal device. In addition, it is possible to improve the utilization efficiency of the radio resources in the second base station device. Further, the terminal device can be connected to the second base station device with low delay.

### Second Embodiment

In a second embodiment, another aspect, in which a terminal device that is connected to a second base station device is connected to and switched over for another second base station device in the communication system in which second base station devices are arranged to overlap with the cell of a first base station device, will be described.

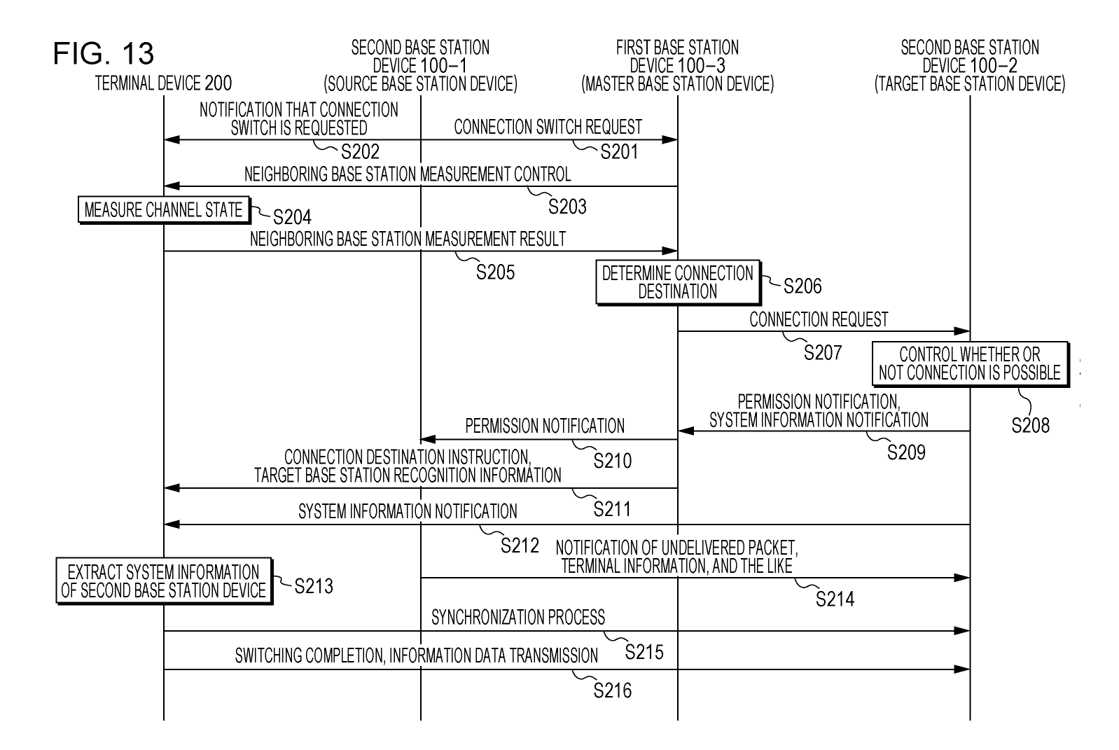

FIG. 13 is a sequence diagram illustrating the terminal device is connected to the second base station device in the communication system according to the second embodiment. In FIG. 1, it is assumed that the terminal device 200 is wirelessly connected to the base station device 100-3 which belongs to the second base station device. In this case, it is assumed that the base station device 100-3 is the source base station device.

When the connection destination of the terminal device 200 is switched, the base station device 100-3 provides a connection switching request to the base station device 100-1 (master base station device), which is the first base station device (S201). For example, the base station device 100-3 continuously receives NACK signals for requesting retransmission in the downlink from the terminal device 200. In addition, when errors of the data channels in the uplink from the terminal device 200 increase, the base station device 100-3 provides the connection switching request. In addition, the terminal device 200 can provide a connection request to the source base station device. In addition, the base station device 100-3 can provide a notification that the connection switching request is provided to the terminal device 200 (S202).

When the terminal device 200 receives a neighboring base station measurement control notification from the base station device 100-1 (S203), which received the connection switching request (S201), the terminal device 200 measures the channel states between the base station device (target base station device candidate), which is designated by the notification, and the terminal device (S204). In FIG. 1, the terminal device 200 measures the channel states between the terminal device 200 and the base station device 100-2, between the terminal device 200 and the base station device 100-4, and between the terminal device 200 and the base station device 100-5. Meanwhile, it is possible to include the base station device 100-1 in the target base station device candidate. It is possible to use the reference signals, which are transmitted by the respective base station devices, in order to measure the channel states. For example, it is possible to use CSI-RS in LTE.

The terminal device 200 notifies the channel state measurement results (neighboring base station measurement results) to the base station device 100-1 (S205). The base station device 100-1 can determine the connection destination based on the neighboring base station measurement results, the resource allocation status of the terminal device, and the like (S206). It is preferable that the source base station device select a base station device, which has excellent channel quality, as the target base station device. In FIG. 13, the base station device 100-1 selects the second base station device 100-2 as the target base station device.

The base station device 100-1 notifies a connection request (for example, handover request) to the base station device 100-2 through backhaul line 10 (S207). The base station device 100-2 determines whether or not connection is possible (S208). When connection is possible, the base station device 100-2 makes preparations for connection such as scheduling (S209). The base station 100-3 notifies the base station device 100-1 of the permission (handover request ACK/NACK) and the system information (S209). The system information includes information relevant to the transmission power of the base station device 100-2 which is the low-power base station. The system information includes the system bandwidth, the system frame number, and the number of transmit antennas of the base station device 100-2.

Here, when the first base station device already maintains the system information, the first base station device can omit the notification of the system information in S209. For example, when the first base station device 100-1 selected the second base station device 100-2, the first base station device 100-1 provides the connection request (S207), as the target base station device in the past, it is possible to omit the notification.

When the base station device 100-1 receives the permission notification (S209), the base station device 100-1 provides the permission notification to the base station device 100-3 (S210). In addition, the base station device 100-1 provides the connection destination instruction for performing connection switching into the base station device 100-2, to the terminal device 200 (S211). Further, the base station device 100-1 notifies the target base station recognition information to the terminal device 200 (S211). The terminal device 200 recognizes whether the target base station device is the first base station device or the second base station device according to the target base station recognition information. The base station device 100-1 notifies the system information of the base station device 100-2 to the terminal device 200 (S212). The base station device 100-1 may notify the system information only when the target base station device is the second base station device.

Here, when the terminal device, which recognizes that the target base station device is the second base station device (base station device 100-2), recognizes the target base station device, the terminal device 200 extracts the system information which is included in the control channels in the downlink (S213).

The base station device 100-3 notifies the terminal information and the undelivered packets of the terminal device 200 to the base station device 100-2 (S214). When the terminal device 200 receives notifications such as the connection destination instruction, the target base station recognition information and the system information (S211, S212, and S213), the terminal device 200 switches a transmission destination and performs the synchronization process using the random access channels for the base station device 100-2 (S215). Further, the terminal device 200 provides a notification that switching into the base station device 100-3 is completed (notification that the connection is established), and transmits the data channels (information data) (S216).

The first base station device according to the second embodiment can include the same configuration as in FIG. 4. The higher layer 101 of the first base station device according to the second embodiment can include a function of transmitting the permission notification to the second base station device through the backhaul line 10 (S210).

The second base station device according to the second embodiment can include the same configuration as in FIG. 5. The higher layer 151 of the second base station device according to the second embodiment can provide notifications such as the terminal information and the undelivered packet information to another second base station device through the backhaul line 10 (S214). The higher layer 151 of the second base station device according to the second embodiment can include information for providing a notification that connection is switched to the data channels in the downlink or the control channels in the downlink (S202). In addition, the higher layer 151 of the second base station device according to the second embodiment can cause the transmission timing information of frequency base station measurement control (S203) which is transmitted by the first base station device (master base station device) to be included in the data channel in the downlink or the control channels in the downlink when the notification that the connection is switched is provided (S202).

The terminal device according to the second embodiment can include the same configuration as in FIG. 6. The higher layer 210 of the terminal device according to the second embodiment can extract information, which is included in the data channels in the downlink or the control channels in the downlink and which provides the notification that the connection is switched, and the transmission timing information of the frequency base station measurement control.

The first base station device according to the second embodiment can map the data channels in the downlink, the control channels in the downlink, the broadcast channels, the downlink synchronization signals, and the downlink reference signals onto resources based on the transmission frame formats of the upper stage of FIG. 4, the upper stage of FIG. 5, the upper stage of FIG. 10, the upper stage of FIG. 11 and the upper stage of FIG. 12. The second base station device according to the second embodiment can map the data channels in the downlink, the control channels in the downlink, the downlink synchronization signals, and the downlink reference signals onto the resources based on the transmission frame formats of the lower stage of FIG. 4, the lower stage of FIG. 5, the lower stage of FIG. 10, the lower stage of FIG. 11, and the lower stage of FIG. 12.

According to the second embodiment, in the communication system which includes the first base station device, at least one second base station device which has lower transmission power than the first base station device, and the terminal device which is connected to the first base station device or the second base station device, it is possible to reduce the broadcast information in a case where the terminal device which is connected to the second base station device changes connection to another second base station device. Therefore, it is possible to efficiently control connecting and switching over for the base station devices and the terminal device. In addition, it is possible to improve the utilization efficiency of the radio resources in the second base station devices. In addition, the terminal device can be connected to the plurality of second base station devices with low delay.

In the second embodiment, the second base station device which is the target base station device of FIG. 13 can directly transmit the permission notification (S209, S210) to the second base station device which is the source base station device through the backhaul line 10. Thereby, the terminal device can be connected to and switched over between the second base station devices with further low delay.

### Third Embodiment

In a third embodiment, another aspect, in which the first base station device provides a notification of whether the subsequent connection destination is the first base station device or the second base station device to the terminal device in the communication system which includes the first base station device, at least one second base station device which has lower transmission power than the first base station device, and the terminal device which is connected to the first base station device or the second base station device, will be described. Hereinafter, differences from the first embodiment will be mainly described.

In the third embodiment, a GI length (CP length) is used as target base station recognition information which is notified to the terminal device by the first base station device. In this case, in the downlink transmission frame formats of the first base station device which are described in the upper stage of FIG. 2, the upper stage of FIG. 3, the upper stage of FIG. 10, the upper stage of FIG. 11, and the upper stage of FIG. 12, the pieces of information of the lengths of the GI of the target base station device are included in the data channels in the downlink or the control channels in the downlink. Therefore, the transmission frame format according to the third embodiment is different from the transmission frame format according to the first embodiment. The embodiment can be implemented by replacing the information relevant to the transmission power of the target base station device, which is the target base station recognition information, in the first embodiment with information relevant to the lengths of the GIs of the target base station device.

The higher layer 101 of the first base station device (base station device 100-1) according to the third embodiment is different from the higher layer 101 according to the first embodiment in that the pieces of information of the lengths of the GIs of the target base station are included in the system information of the target base station device (S107 of FIGS. 9 and S209 of FIG. 13) which is acquired through the backhaul line 10. The higher layer 101 according to the third embodiment can determine whether the target base station device is the first base station device or the second base station device according to the pieces of information of the lengths of the GIs.

The first base station device according to the third embodiment is different from the first base station device according to the first embodiment in that the pieces of information relevant to the lengths of the GIs of the target base station device are notified (S108 of FIGS. 9 and S211 of FIG. 13) to the terminal device as the target base station recognition information. The first base station device according to the third embodiment can cause the data channels in the downlink which are generated by the data channel generation unit 102 or the control channels in the downlink which are generated by the control channel generation unit 103 to include the pieces of information relevant to the lengths of the GIs of the target base station device which is notified by the higher layer 101.

The first base station device according to the third embodiment causes the pieces of information relevant to the lengths of the GIs of the target base station device to be included in the data channels in the downlink or the control channels in the downlink only when the target base station device is the second base station device. The first base station device according to the third embodiment may cause the pieces of information relevant to the lengths of the GIs of the target base station device to be included in the data channels in the downlink or the control channels in the downlink only when the lengths of the GIs of the target base station device are different from the lengths of the GIs of the base station device. The first base station device according to the third embodiment may cause the pieces of information relevant to the lengths of the GIs of the target base station device to be included in the data channels in the downlink or the control channels in the downlink only when the lengths of the GIs of the target base station device are shorter than the lengths of the GIs of the base station device.

The terminal device recognizes whether the target base station device is the first base station device or the second base station device according to the target base station recognition information. More specifically, the higher layer 210 of the terminal device extracts the pieces of information relevant to the lengths of the GIs of the target base station device, which are included in the data channels in the downlink or the control channels in the downlink which are transmitted by the first base station device. The higher layer 210 determines whether the target base station device is the first base station device or the second base station device based on the pieces of information relevant to the lengths of the GIs. For example, the base station device 100-1 transmits the pieces of information relevant to the lengths of the GIs of the target base station device when the target base station is the second base station device. In this case, the terminal device can recognize that the target base station device is the second base station device when it is possible to acquire the pieces of information relevant to the lengths of the GIs of the target base station device from a prescribed resource element. In addition, it is assumed that setting is made such that the length of the GIs of the OFDM symbol which is transmitted by the first base station device is A and the GI length of the OFDM symbol which is transmitted by the second base station device is B (B<A). In this case, when the terminal device acquires B as the information relevant to the length of the GI of the target base station device, the terminal device recognizes that the target base station device is the second base station device.

When the terminal device recognizes that the target base station device is the second base station device, the terminal device extracts the system information, which is included in the data channels in the downlink or the control channels in the downlink which are notified by the base station device 100-1 in S109 of FIG. 9 (S212 of FIG. 13), (S110 of FIGS. 9 and S213 of FIG. 13).

According to the third embodiment, in the communication system which includes the first base station device, at least one second base station device which has lower transmission power than the first base station device, and the terminal device which is connected to the first base station device or the second base station device, the terminal device can recognize whether or not the base station device, which is the connection destination, is the second base station device according to the pieces of information relevant to the lengths of the GIs, and the terminal device can acquire the control information of the second base station device from the first base station device. Therefore, in the system, it is possible to reduce the control information which is transmitted to the terminal device by the second base station device (low-power base station device). Therefore, it is possible to efficiently control connecting and switching over for the base station device and the terminal device. In addition, it is possible to improve the utilization efficiency of the radio resources in the second base station device. Further, the terminal device can be connected to the second base station device with low delay.

### Fourth Embodiment

In a fourth embodiment, another aspect, in which the first base station device provides a notification of whether the subsequent connection destination is the first base station device or the second base station device to the terminal device in the communication system which includes the first base station device, at least one second base station device which has lower transmission power than the first base station device, and the terminal device which is connected to the first base station device or the second base station device, will be described. Hereinafter, differences from the first embodiment will be mainly described.

In the fourth embodiment, a usable frequency band is used as the target base station recognition information which is notified to the terminal device by the first base station device. In this case, in the downlink transmission frame formats of the first base station device which are described in the upper stage of FIG. 2, the upper stage of FIG. 3, the upper stage of FIG. 10, the upper stage of FIG. 11, and the upper stage of FIG. 12, the information of the usable frequency band of the target base station device is included in the data channels in the downlink or the control channels in the downlink. Therefore, the transmission frame format according to the fourth embodiment is different from the transmission frame format according to the first embodiment. The embodiment can be implemented by replacing the information relevant to the transmission power of the target base station device, which is the target base station recognition information, in the first embodiment with information relevant to the usable frequency band of the target base station device.

The higher layer 101 of the first base station device (base station device 100-1) according to the fourth embodiment is different from the higher layer 101 according to the first embodiment in that the information relevant to the usable frequency band of the target base station is included in the system information of the target base station device which is acquired through the backhaul line 10 (S107 of FIGS. 9 and S209 of FIG. 13). The higher layer 101 according to the fourth embodiment can determine whether the target base station device is the first base station device or the second base station device according to the information relevant to the usable frequency band.

The first base station device according to the fourth embodiment is different from the first base station device according to the first embodiment in that the information relevant to the usable frequency band of the target base station device is notified to the terminal device (S108 of FIGS. 9 and S211 of FIG. 13) as the target base station recognition information. The first base station device according to the fourth embodiment can cause the data channels in the downlink which are generated by the data channel generation unit 102 or the control channels in the downlink generated by the control channel generation unit 103 to include the information relevant to the usable frequency band of the target base station device which is notified by the higher layer 101.

The first base station device according to the fourth embodiment causes the information relevant to the usable frequency band of the target base station device to be included in the data channels in the downlink or the control channels in the downlink only when the target base station device is the second base station device. The first base station device according to the fourth embodiment may cause the information relevant to the usable frequency band of the target base station device to be included in the data channels in the downlink or the control channels in the downlink only when the usable frequency band of the target base station device is different from the usable frequency band of the base station device. The first base station device according to the fourth embodiment may cause the information relevant to the usable frequency band of the target base station device to be included in the data channels in the downlink or the control channels in the downlink only when the usable frequency band of the target base station device is higher than the usable frequency band of the base station device.

The terminal device recognizes whether the target base station device is the first base station device or the second base station device according to the target base station recognition information. More specifically, the higher layer 210 of the terminal device extracts the information relevant to the usable frequency band of the target base station device which is included in the data channels in the downlink or the control channels in the downlink which are transmitted by the first base station device. The higher layer 210 determines whether the target base station device is the first base station device or the second base station device based on the information relevant to the usable frequency band. For example, the base station device 100-1 transmits the information relevant to the usable frequency band of the target base station device when the target base station is the second base station device. In this case, the terminal device 200 can recognize that the target base station device is the second base station device when it is possible to acquire the information relevant to the usable frequency band of the target base station device from a prescribed resource element. In addition, when the base station device 100-1 transmits the usable frequency band as the information relevant to the usable frequency band of the target base station device, it is possible to determine whether the target base station device is the first base station device or the second base station device according to the usable frequency band.

When it is recognized that the target base station device is the second base station device, the terminal device extracts the system information, which is included in the data channels in the downlink or the control channels in the downlink that are notified by the base station device 100-1 in S109 of FIG. 9 (or S212 of FIG. 13), (S110 of FIGS. 9 and S213 of FIG. 13).

According to the fourth embodiment, in the communication system which includes the first base station device, at least one second base station device which has lower transmission power than the first base station device, and the terminal device which is connected to the first base station device or the second base station device, the terminal device can recognize whether or not the base station device, which is the connection destination, is the second base station device according to the information relevant to the usable frequency band, and the terminal device can acquire the control information of the second base station device from the first base station device. Therefore, it is possible to reduce the control information which is transmitted to the terminal device by the second base station device (low-power base station device). Therefore, in the system, it is possible to efficiently control connecting and switching over for the base station device and the terminal device. In addition, it is possible to improve the utilization efficiency of the radio resources. Further, the terminal device can be connected to the plurality of base station devices with low delay.

### Fifth Embodiment

In a fifth embodiment, another aspect, in which the first base station device provides a notification of whether the subsequent connection destination is the first base station device or the second base station device to the terminal device in the communication system which includes the first base station device, at least one second base station device which has lower transmission power than the first base station device, and the terminal device which is connected to the first base station device or the second base station device, will be described. In the fifth embodiment, the first base station device provides a notification of whether the subsequent connection destination (handover destination) is the first base station device or the second base station device to the terminal device which is connected to the base station device according to the presence/non-presence of a positional information measurement instruction. Hereinafter, differences from the first embodiment will be mainly described.

The first base station device allocates information relevant to a positional information notification instruction to the data channels in the downlink or the control channels in the downlink as the target base station recognition information when the terminal device, which is connected to the base station device, is connected to the second base station device. The first base station device allocates information relevant to the positional information notification instruction to the data channels in the downlink or the control channels in the downlink of the upper stage of FIG. 2, the upper stage of FIG. 3, the upper stage of FIG. 10, the upper stage of FIG. 11, and the upper stage of FIG. 12.

The first base station device according to the fifth embodiment is different from the first base station device according to the first embodiment in that the higher layer 101 of FIG. 4 includes a positional information detection function. The control signal detection unit 123 of the first base station device extracts positional information, which is included in the uplink signals from the terminal device 200, through the receive antenna unit 121-x (x=1, . . . , N_{R}) and the reception unit 122. The higher layer 101 determines the base station device (target base station device) which is the connection destination of the terminal device based on the positional information. The higher layer 101 requests to determine whether or not it is possible to connect the target base station device through the backhaul line 10 (provides a connection request).

In addition, the first base station device according to the fifth embodiment is different from the first base station device according to the first embodiment in that the information relevant to the positional information notification instruction is included in the data channels in the downlink which are generated by the data channel generation unit 102 or the control channels in the downlink which are generated by the control channel generation unit 103 in FIG. 4. The second base station device according to the fifth embodiment has the same configuration as in FIG. 5.

Subsequently, the terminal device according to the fifth embodiment will be described. The terminal device according to the fifth embodiment is different from the first base station device according to the first embodiment in that the higher layer 210 of FIG. 6 has a positional information measurement function. The higher layer 210 measures the positional information of the terminal 200 based on channel information which is input from the channel estimation unit 204, and outputs the positional information to the data channel generation unit 224 or the control channel generation unit 225. The positional information can be information which indicates the geographic position or information which indicates the relative position of the terminal device 200. The positional information is not limited to the channel information and may be calculated using another method.

For example, it is possible to use information, which is measured using the Global Positioning System (GPS), as the information which indicates the geographic position. As the information which indicates the relative position, it is possible to use information, which is measured using positioning reference signals transmitted from the first base station device 100-1, as in a case of, for example, Long Term Evolution (LTE) or LTE-Advanced (LTE-A). In addition, reception qualities between the respective base stations, which are measured using cell specific reference signals, may be used in addition to the positional information.

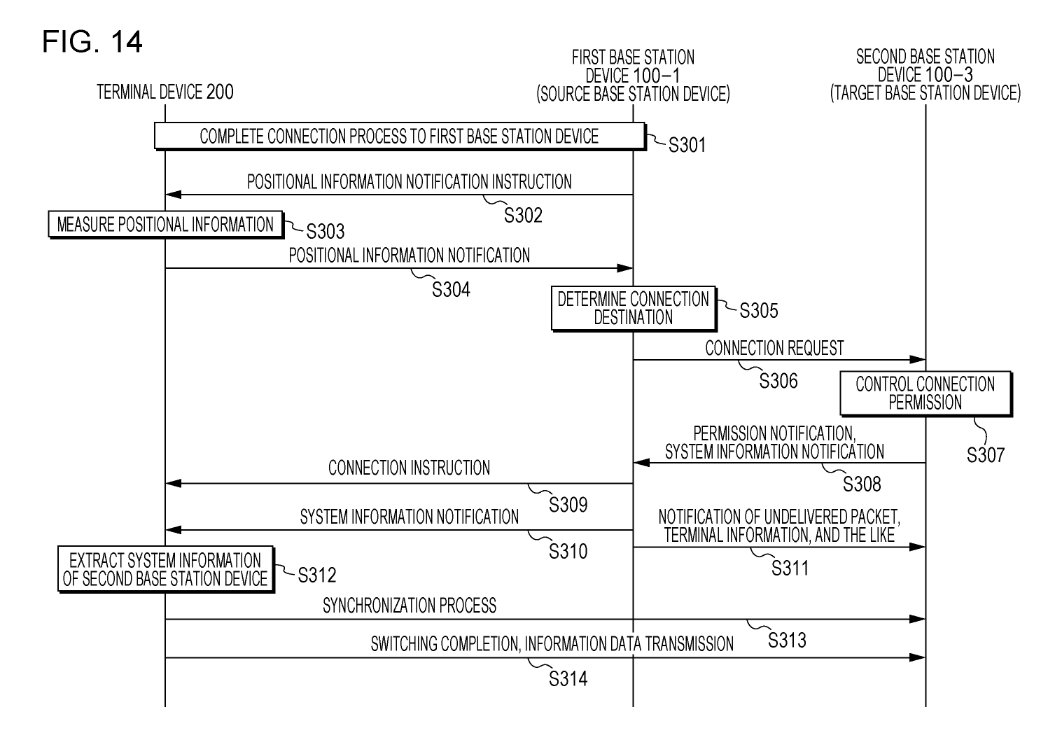

Subsequently, an operation of connecting the first base station device, the second base station device, and the terminal device in the communication system according to the fifth embodiment will be described. FIG. 14 is a sequence diagram illustrating a case in which the terminal device is connected to the second base station device in the communication system according to the fifth embodiment. FIG. 14 illustrates a case in which connection switching is performed from the terminal device, which is connected to the first base station device 100-1, into the second base station device 100-3.

In FIG. 1, when power is supplied, the terminal device 200 establishes connection to the first base station device (S301). More specifically, when power is supplied, the terminal 200 performs cell searching of the base station device to be connected. Here, the terminal 200 searches the first base station device for the base station device to be connected. The terminal device 200 performs the cell searching using a synchronization sequence (synchronization channel) which is generated based on a cell ID which is allocated to the first base station device. In addition, the terminal device 200 searches for the base station device to be connected from the first base station device by performing the cell searching for only the frequency band of the first base station device.

After the cell searching, the cell is found, the terminal device 200 receives the broadcast channels of the selected first base station device, and establishes connection to the first base station device. In FIG. 14, the terminal device 200 selects the base station device 100-1 through the cell searching, and establishes the connection. Subsequently, connection switching is performed from the base station device 100-1 into the second base station device.

When the first base station device performs connection switching from the connected terminal device into the second base station device, the first base station device notifies the terminal device of the positional information notification instruction (S302).

When the terminal device receives the positional information notification instruction (S302), the terminal device measures positional information (S303) and notifies the results of measurement to the first base station device (S304). The terminal device receives the positional information notification instruction, and recognizes that the target base station device is the second base station device (low-power base station device or small cell base station device).

Subsequently, when the first base station device receives positional information notification (S304), the first base station device determines the connection destination based on the positional information (S305). The first base station device calculates the distance between the positional information of the terminal device 200 and each of the base station devices 100-2 to 100-5. It is preferable that the first base station device which has the shortest distance be set to the target base station device. For example, in FIG. 1, when the distance to the second base station device 100-3 is the shortest, the terminal device 200 sets the connection destination to the cell ID of the second base station device 100-3.

In addition, the first base station device may measure the positional information of the terminal device, and may determine the target base station device by taking the results of the determination into consideration. For example, the first base station device measures the positional information using the reference signals and the control signals which are transmitted by the terminal device. Therefore, the first base station device can determine the target base station device using the positional information which is notified by the terminal device and the positional information which is measured by the first base station device.

Subsequently, the first base station device notifies the connection request (for example, handover request) to the connection destination (second base station device 100-3) through the backhaul line 10 (S306). The second base station device determines whether or not connection is possible (S307). When connection is possible, the second base station device makes preparations for connection such as scheduling (S307). The second base station device provides the permission notification (handover request ACK/NACK) and the system information to the first base station device (S308). The system information includes the number of transmit antennas, the system bandwidth, the system frame number, the frame timing of the base station device, the information relevant to the symbol timing, and the broadcast information.

When the first base station device receives the permission notification (S308), the first base station device notifies the terminal information of the terminal device and the undelivered packets to the second base station device which is the target base station device (S311).

When the first base station device 100-1 receives the permission notification (S308), the first base station device 100-1 provides the connection destination instruction for performing connection switching into the second base station device 100-3, to the terminal device 200 (S309). In addition, since the target base station device is the second base station device 100-3, the first base station device 100-1 notifies the system information of the second base station device 100-3 to the terminal device 200 (S310). Since the terminal device recognizes that the target base station device is the second base station device according to the positional information notification instruction which is received in S302, the terminal device extracts the system information included in the data channels in the downlink or the control channels in the downlink (S312). Here, when the first base station device 100-1 already maintains the system information, it is possible to omit the notification of the system information in S310. For example, it is possible to omit the second base station device 100-3, to which the connection instruction (S309) is provided by the first base station device 100-1, when the second base station device 100-3 was selected as the target base station device in the past.

When the terminal device 200 receives the notifications such as the connection destination instruction and the system information (S309 and S310), the terminal device 200 switches a transmission destination and performs a synchronization process using the random access channels between the terminal device 200 and the target base station device (S313). Further, the terminal device provides a notification that switching into the target base station device is completed (notification that the connection is established), and transmits the data channels (information data) (S314).

According to the fifth embodiment, in the communication system which includes the first base station device, at least one second base station device which has lower transmission power than the first base station device, and the terminal device which is connected to the first base station device or the second base station device, the terminal device can recognize whether or not the base station device, which is the connection destination, is the second base station device according to the positional information, and the terminal device can acquire the control information of the second base station device from the first base station device. Therefore, in the system, the second base station device (low-power base station device) can reduce the control information to be transmitted to the terminal device. Therefore, it is possible to efficiently control connecting and switching over for the base station device and the terminal device. In addition, it is possible to improve the utilization efficiency of the radio resources in the second base station device. Further, the terminal device can be connected to the second base station devices with low delay.

Meanwhile, a program, which is operated in the terminal device or the base station device according to the present invention, is a program for controlling a CPU or the like (program for causing a computer to function) such that the functions of the embodiment according to the present invention are realized. Further, information, which is treated in the devices, is temporarily accumulated in a RAM when the information is processed. Thereafter, the information is stored in various ROMs or HDDs, is read by the CPU if necessary, and modified or written. Any one of a semiconductor medium (for example, a ROM, a non-volatile memory card, or the like), an optical storage medium (for example, a DVD, a MO, a MD, a CD, BD, or the like), and a magnetic recording medium (for example, a magnetic tape, a flexible disk, or the like) may be used as a medium which stores the program. In addition, when a loaded program is executed, there is a case in which the functions of the above-described embodiment are realized and the functions according to the present invention are realized by cooperatively processing an operating system or another application program based on the instruction of the program.

In addition, when distributing the program in the market, it is possible to distribute the program by storing the program in a portable recording medium or it is possible to transmit the program to a server computer which is connected through a network such as the Internet. In this case, the storage device of the server computer is included in the present invention. In addition, some parts or the entirety of the terminal device and the base station device in the above-described embodiment may be realized as an LSI which is typically an integrated circuit. Each of the functional blocks of the reception device may be formed as an individual chip. Otherwise, some or the entirety of the functional blocks may be integrated and form a chip. When each of the functional blocks forms an integrated circuit, an integrated circuit control unit which controls the functional blocks is added.

In addition, an integrated circuit method is not limited to the LSI and may be realized using a dedicated circuit or a general-purpose processor. In addition, when an integrated circuit technology, which replaces the LSI, appears due to improvement in a semiconductor technology, it is possible to use an integrated circuit according to the technology.

In addition, the terminal device of the present invention is not limited to be applied to a mobile station device. It is apparent that it is possible to apply the present invention to a stationary type or non-movable electronic device which is installed indoors or outdoors, for example, an AV device, a kitchen appliance, a cleaning or washing machine, an air conditioner, an office device, a vending machine, or another home appliance.

Hereinabove, although the embodiments of the present invention have been described with reference to the accompanying drawings, detailed configurations are not limited to the embodiments and designs or the like which do not depart from the gist of the present invention are included in the claims.

### INDUSTRIAL APPLICABILITY

It is preferable to use the present invention for a communication system, a communication method, a base station device, and a terminal device.

### REFERENCE SIGNS LIST

10 backhaul line
100-1 first base station device
100-2, 100-3, 100-4, 100-5 second base station device
101 higher layer
102 data channel generation unit
103 control channel generation unit
104 control signal generation unit
105 reference signal generation unit
106 resource mapping unit
107 transmission signal generation unit
108 transmission unit
109-N_{T} transmit antenna unit
121-N_{R} receive antenna unit
122 reception unit
123 control signal detection unit
151 higher layer
152 data channel generation unit
153 control channel generation unit
154 control signal generation unit
155 reference signal generation unit
156 resource mapping unit
157 transmission signal generation unit
158 transmission unit
159-N_{T} transmit antenna unit
171-N_{R} receive antenna unit
172 reception unit
173 control signal detection unit
200 terminal device
201-N_{R} receive antenna unit
202 reception unit
203 reception signal processing unit
204 channel estimation unit
205 control channel processing unit
206 data channel processing unit
210 higher layer
221-N_{T} transmit antenna unit
222 transmission unit
223 transmission signal generation unit
224 data channel generation unit
225 control channel generation unit
226 reference signal generation unit
301-y first valid symbol
301-ya first guard interval
401-z second valid symbol
401-za second guard interval

1. A base station device, which is a first base station device of a communication system that includes the first base station device, at least one second base station device, and a terminal device which is connected to the first base station device or the second base station device, the base station device comprising:
a transmission unit that transmits channels in the downlink including target base station recognition information and channels in the downlink including system information of the second base station device in order to provide a notification of whether or not a subsequent connection destination is the second base station device to the terminal device.

2. The base station device according to claim 1,
wherein the target base station recognition information includes information relevant to transmission power of the base station device.

3. The base station device according to claim 1,
wherein the target base station recognition information includes information relevant to a length of a guard interval of the base station device.

4. The base station device according to claim 1,
wherein the target base station recognition information includes positional information of the base station device.

5. The base station device according to claim 1,
wherein the transmission unit transmits the target base station recognition information in a case in which the subsequent connection destination is the second base station device.

6. A terminal device of a communication system that includes a first base station device, at least one second base station device, and the terminal device which is connected to the first base station device or the second base station device, the terminal device comprising:
a reception unit that receives channels in the downlink including target base station recognition information and channels in the downlink including system information of the second base station device from the first base station device in order to provide a notification of whether or not a subsequent connection destination is the second base station device to the terminal device; and
a transmission unit that transmits signals based on a transmission frame format of the second base station device in a case in which the subsequent connection destination is the second base station device.

7. The terminal device according to claim 6,
wherein the target base station recognition information includes information relevant to transmission power of the base station device, and
wherein the terminal device further comprises a higher layer that determines whether the connection destination is the first base station device or the second base station device based on the information relevant to the transmission power.

8. The terminal device according to claim 6,
wherein the target base station recognition information includes information relevant to a length of a guard interval of the base station device, and
wherein the terminal device further comprises a higher layer that determines whether the connection destination is the first base station device or the second base station device based on the information relevant to the length of the guard interval of the base station device.

9. The terminal device according to claim 6,
wherein the target base station recognition information is positional information of the base station device, and
wherein the terminal device further comprises a higher layer that determines whether the connection destination is the first base station device or the second base station device based on the positional information of the base station device.

10. The terminal device according to claim 6,
wherein, in a case in which the subsequent connection destination is the second base station device, the transmission unit adds a guard interval having a length based on a transmission symbol format of the second base station device.

11. The terminal device according to claim 6,
wherein, in a case in which the higher layer recognizes that the subsequent connection destination is the second base station device, the reception unit acquires the system information of the second base station device from the channels in the downlink which are received from the first base station device.

12-22. (canceled)
